(19) United States
(12) Patent Application Publication
(10) Pub. No.: US 2010/0125492 A1
(43) Pub. Date: May 20, 2010

(54) System and method for providing contextual advertisements according to dynamic pricing scheme

(75) Inventors: Gloria Lin, San Ramon, CA (US); Michael Rosenblatt, Campbell, CA (US)

Correspondence Address: APPLE INC.;c/o Fletcher Yoder, PC, P.O. Box 692289, Houston, TX, 77269-2289, US

(73) Assignee: Apple Inc.

(21) Appl. No.: 12/291,969

(22) Filed: Nov. 14, 2008

(51) Int. Cl. G06Q 30/00; G06Q 40/00; G06Q 20/00; G06Q 90/00

(52) U.S. Cl. 705/14.5; 705/35; 705/400

(57) ABSTRACT

Systems, methods, and devices for providing electronic advertisements according to a dynamic pricing scheme are provided. For example, a method for providing an electronic advertisement according to a dynamic pricing scheme may include transmitting an advertisement to an electronic device belonging to a user and receiving marketing factors indicating a likelihood that the user will be receptive to the advertisement. The advertisement may be configured for display on the electronic device and at least one of the marketing factors may be received from the electronic device. A price for providing the advertisement to the target user may be determined based on the marketing factors.

### BACKGROUND

1. Technical Field

The present disclosure relates generally to providing advertisements and, more particularly, to providing dynamically priced advertisements to an electronic device.

2. Description Of The Related Art

This section is intended to introduce the reader to various aspects of art that may be related to various aspects of the present disclosure, which are described or claimed below. This discussion is believed to be helpful in providing the reader with background information to facilitate a better understanding of the various aspects of the present disclosure. Accordingly, it should be understood that these statements are to be read in this light, and not as admissions of prior art.

A person may have one or more electronic devices capable of displaying advertisements. An advertiser may pay for advertisements to be displayed on such electronic devices belonging to the person. However, the pricing scheme for the advertisements may not account for many factors that may influence the efficacy of the advertisements.

### SUMMARY

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may be set forth below.

By way of example, a method for providing an electronic advertisement according to a dynamic pricing scheme may include transmitting an advertisement to an electronic device belonging to a user and receiving marketing factors indicating a likelihood that the user will be receptive to the advertisement. The advertisement may be configured for display on the electronic device and at least one of the marketing factors may be received from the electronic device. A price for providing the advertisement to the target user may be determined based on the marketing factors.

### BRIEF DESCRIPTION OF THE DRAWINGS

Advantages of the invention may become apparent upon reading the following detailed description and upon reference to the drawings in which:

FIG. 1 is a block diagram illustrating an electronic device 10 configured to display an electronic advertisement or determine a dynamic price for the electronic advertisement;

FIG. 2 is a schematic of a handheld device representing an embodiment of the electronic device of FIG. 1;

FIG. 3 is a schematic of a computer representing an embodiment of the electronic device of FIG. 1;

FIG. 4 is a schematic of a standalone media player representing an embodiment of the electronic device of FIG. 1;

FIG. 5 is a schematic of a wireless base station representing an embodiment of the electronic device of FIG. 1;

FIG. 6 is a schematic of a radio frequency identification tag that may be used to initiate an advertisement sequence;

FIGS. 7A-B is a block diagram of a dynamically-priced advertisement system;

FIG. 8 is a flowchart describing a manner of providing probability-based dynamically-priced advertisements;

FIG. 9 is a flowchart describing a manner of providing results-based dynamically-priced advertisements;

FIG. 10 is a flowchart describing a manner of providing probability-based and results-based dynamically-priced advertisements;

FIG. 11 is a flowchart describing a manner of providing probability-based or results-based dynamically-priced web advertisements;

FIG. 12 is a block diagram illustrating various marketing factors that may be employed to determine a price of a dynamically-priced advertisement;

FIG. 13 is a block diagram illustrating various follow-up factors that may be employed to determine a price of a dynamically-priced advertisement;

FIG. 14 is a schematic of a radio-frequency-identification-tag-scanning operation;

FIGS. 15A-B are schematics of screens that may be displayed following the radio-frequency-identification-tag-scanning operation of FIG. 14;

FIG. 16 is a block diagram illustrating communication that may take place during the radio-frequency-identification-tag-scanning operation of FIG. 14;

FIG. 17 is a schematic of a city plan in which the dynamically-priced advertisement system may be deployed;

FIG. 18 is a block diagram illustrating a manner of transmitting advertising beacons in the dynamically-priced advertisement system deployment of FIG. 17;

FIGS. 19A-C are schematics of screens that may be displayed upon receiving a beacon in the dynamically-priced advertisement system deployment of FIG. 17;

FIGS. 20A-C are schematics of alternative screens that may be displayed upon receiving a beacon in the dynamically-priced advertisement system deployment of FIG. 17;

FIG. 21 is a block diagram illustrating communication that may take place in the dynamically-priced advertisement system deployment of FIG. 17;

FIGS. 22A-C are schematics of screens that may be displayed when an advertisement sequence is initiated by a user selection;

FIG. 23 is a block diagram illustrating communication that may take place upon the advertisement sequence initiation of FIGS. 22A-B;

FIGS. 24A-B are schematics of screens that may be displayed when a map application initiates an advertisement sequence; and

FIGS. 25A-D are schematics of screens that may be displayed when a web browser application initiates an advertisement sequence.

### DETAILED DESCRIPTION OF SPECIFIC EMBODIMENTS

Many people use a personal electronic device each day, as portable phones and digital media players become commonplace. Using the techniques, systems, and devices described in the disclosure below, a user may view and use a variety of advertisements from various advertisers on a personal electronic device. Based on a dynamic pricing scheme, the advertisers may pay a variable price for an advertisement based on the likelihood of influencing user behavior.

One or more specific embodiments of the present invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

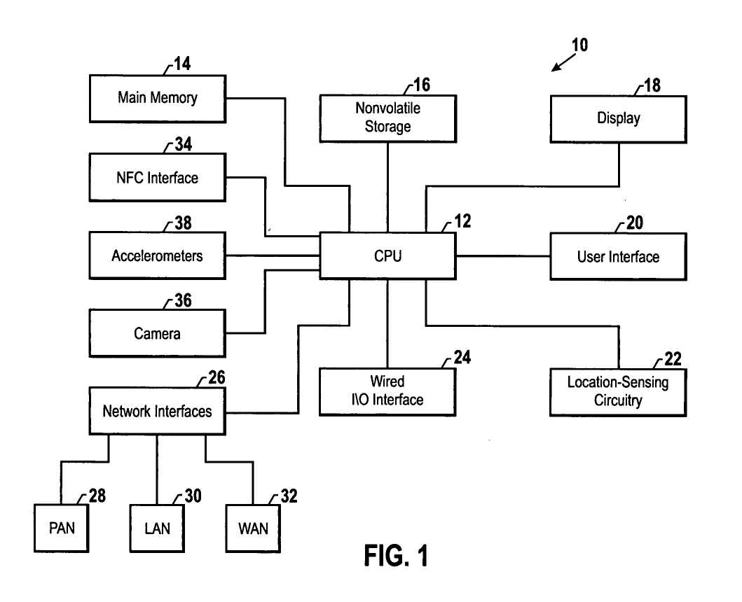

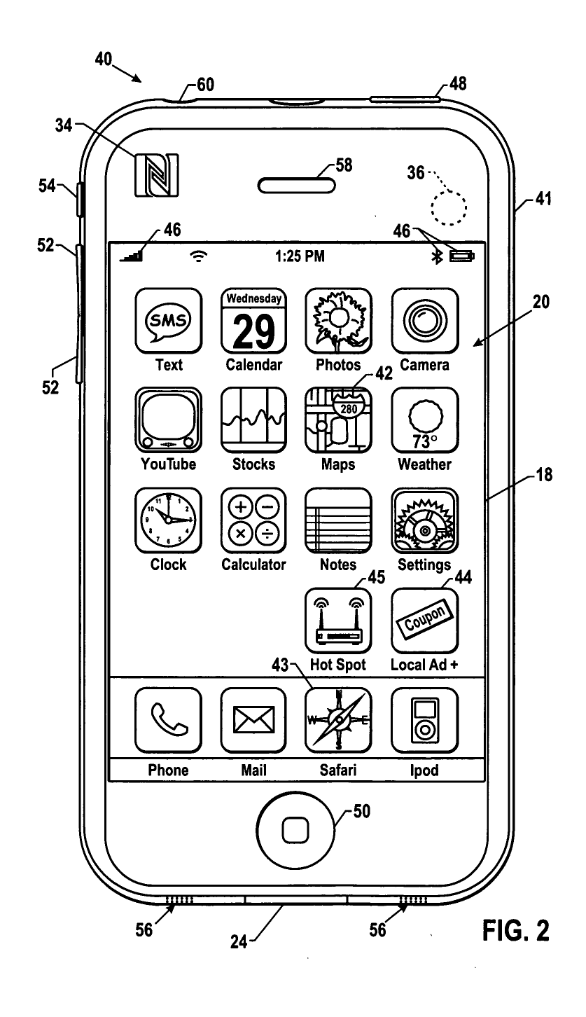

Turning first to FIG. 1, an electronic device 10 may be configured for obtaining, storing, and/or viewing advertisements. As discussed below with reference to FIGS. 2-5, the electronic device 10 may represent, among other things, a handheld device, a computer, a media player, or a wireless base station adapted to transmit, receive, and/or display advertisements. As such, the electronic device 10 may represent, for example, an iPhone®, iPod®, iMac®, MacBook®, AppleTV®, or AirPort® available from Apple, Inc., or other devices by any manufacturer. It should be appreciated that embodiments of the electronic device 10 may include more or fewer elements than depicted in FIG. 1.

The electronic device 10 may include at least one central processing unit (CPU) 12. For example, the CPU 12 may represent one or more microprocessors, and the microprocessors may be “general purpose” microprocessors, a combination of general and special purpose microprocessors, or ASICS. Additionally or alternatively, the CPU 12 may include one or more reduced instruction set (RISC) processors, video processors, or related chip sets. The CPU 12 may provide processing capability to execute an operating system, run various applications, and/or provide processing for one or more of the techniques described herein. Applications that may run on the electronic device 10 may include, for example, software for managing and playing audiovisual content, software for displaying and managing electronic maps, software for controlling telephone capabilities, software for browsing web content on the Internet, and software for managing electronic advertisements, as noted below.

A main memory 14 may be communicably coupled to the CPU 12, which may store data and executable code. The main memory 14 may represent volatile memory such as RAM, but may also include nonvolatile memory, such as read-only memory (ROM) or Flash memory. In buffering or caching data related to operations of the CPU 12, the main memory 14 may store data associated with applications running on the electronic device 10.

The electronic device 10 may also include nonvolatile storage 16. The nonvolatile storage 16 may represent any suitable nonvolatile storage medium, such as a hard disk drive or nonvolatile memory, such as Flash memory. Being well-suited to long-term storage, the nonvolatile storage 16 may store data files such as media (e.g., music and video files), software (e.g., for implementing functions on the electronic device 10), preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish a wireless connection such as a telephone connection), subscription information (e.g., information that maintains a record of podcasts or television shows or other media a user subscribes to), as well as telephone information (e.g., telephone numbers). It should be appreciated that certain data regarding the efficacy of a received advertisement may be saved in the nonvolatile storage 16, as discussed further below.

A display 18 may display images and data for the electronic device 10. It should be appreciated that only certain embodiments may include the display 18. The display 18 may be any suitable display, such as liquid crystal display (LCD), a light emitting diode (LED) based display, an organic light emitting diode (OLED) based display, a cathode ray tube (CRT) display, or an analog or digital television. In some embodiments, the display 18 may function as a touch screen through which a user may interact with the electronic device 10.

The electronic device 10 may further include a user interface 20. The user interface 20 may represent indicator lights and user input structures, but may also include a graphical user interface (GUI) on the display 18. In practice, the user interface 20 may operate via the CPU 12, using memory from the main memory 14 and long-term storage in the nonvolatile storage 16. In an embodiment lacking the display 18, indicator lights, sound devices, buttons, and other various input/output (I/O) devices may allow a user to interface with the electronic device 10. In an embodiment having a GUI, the user interface 20 may provide interaction with interface elements on the display 18 via certain user input structures, user input peripherals such as a keyboard or mouse, or a touch sensitive implementation of the display 18.

As should be appreciated, one or more applications may be open and accessible to a user via the user interface 20 and displayed on the display 18 of the electronic device 10. The applications may run on the CPU 12 in conjunction with the main memory 14, the nonvolatile storage 16, the display 18, and the user interface 20. As will be discussed in greater detail below, instructions stored in the main memory 14, the nonvolatile storage 16, or the CPU 12 of the electronic device 10 may obtain, store, and display electronic advertisements. It should be appreciated that the instructions for carrying out such techniques may represent a standalone application, a function of the operating system of the electronic device 10, or a function of the hardware of the CPU 12, the main memory 14, the nonvolatile storage 16, or other hardware of the electronic device 10.

In certain embodiments, the electronic device 10 may include location sensing circuitry 22. The location sensing circuitry 22 may represent global positioning system (GPS) circuitry, but may also represent one or more algorithms and databases, stored in the nonvolatile storage 16 or main memory 14 and executed by the CPU 12, which may be used to infer location based on various observed factors. For example, the location sensing circuitry 22 may represent an algorithm and database used to approximate geographic location based on the detection of local 802.11x (Wi-Fi) networks or nearby cellular phone towers. As discussed below, the electronic device 10 may employ the location sensing circuitry 22 as a factor for carrying out certain advertisement management techniques. By way of example, the location sensing circuitry 22 may be used by the electronic device 10 to determine a user's location while viewing or requesting an advertisement; the location be used to alter the advertisement or to vary the price of the advertisement, as described further below.

With continued reference to FIG. 1, the electronic device 10 may also include a wired input/output (I/O) interface 24 for a wired interconnection between one electronic device 10 and another electronic device 10. The wired I/O interface 24 may represent, for example, a universal serial bus (USB) port or an IEEE 1394 or FireWire® port, but may also represent a proprietary connection. Additionally, the wired I/O interface 24 may permit a connection to user input peripheral devices, such as a keyboard or a mouse.

One or more network interfaces 26 may provide additional connectivity for the electronic device 10. The network interfaces 26 may represent, for example, one or more network interface cards (NIC) or a network controller. In certain embodiments, the network interface 26 may include a personal area network (PAN) interface 28. The PAN interface 28 may provide capabilities to network with, for example, a Bluetooth® network, an IEEE 802.15.4 (e.g., ZigBee) network, or an ultra wideband network (UWB). As should be appreciated, the networks accessed by the PAN interface 28 may, but do not necessarily, represent low power, low bandwidth, or close range wireless connections. The PAN interface 28 may permit one electronic device 10 to connect to another local electronic device 10 via an ad-hoc or peer-to-peer connection. However, the connection may be disrupted if the separation between the two electronic devices 10 exceeds the range of the PAN interface 28.

The network interface 26 may also include a local area network (LAN) interface 30. The LAN interface 30 may represent an interface to a wired Ethernet-based network, but may also represent an interface to a wireless LAN, such as an IEEE 802.11x wireless network. The range of the LAN interface 30 may generally exceed the range available via the PAN interface 28. Additionally, in many cases, a connection between two electronic devices 10 via the LAN interface 30 may involve communication through a network router or other intermediary device.

For some embodiments of the electronic device 10, the network interfaces 26 may include the capability to connect directly to a wide area network (WAN) via a WAN interface 32. The WAN interface 32 may permit a connection to a cellular data network, such as the Enhanced Data rates for GSM Evolution (EDGE) network or other 3G network. When connected via the WAN interface 32, the electronic device 10 may remain connected to the Internet and, in some embodiments, to another electronic device 10, despite changes in location that might otherwise disrupt connectivity via the PAN interface 28 or the LAN interface 30. As will be discussed below, the wired I/O interface 24 and the network interfaces 26 may represent high-bandwidth communication channels for transferring user data using the simplified data transfer techniques discussed herein.

Certain embodiments of the electronic device 10 may also include a near field communication (NFC) interface 34. The NFC interface 34 may allow for extremely close range communication at relatively low data rates (e.g., 464 kb/s), and may comply with such standards as ISO 18092 or ISO 21521, or it may allow for close range communication at relatively high data rates (e.g., 560 Mbps), and may comply with the TransferJet® protocol. The NFC interface 34 may have a range of approximately 2 to 4 cm. The close range communication with the NFC interface 34 may take place via magnetic field induction, allowing the NFC interface 34 to communicate with other NFC interfaces 34 or to retrieve information from tags having radio frequency identification (RFID) circuitry. As discussed below, the NFC interface 34 may provide a manner of initiating or facilitating a transfer of user data from one electronic device 10 to another electronic device 10.

The electronic device 10 of FIG. 1 may also include a camera 36. With the camera 36, the electronic device 10 may obtain digital images or videos. In combination with optical character recognition (OCR) software, barcode-reading software, or matrix-code-reading software running on the electronic device 10, the camera 36 may be used to input data from printed materials having text or barcode information. Such data may include electronic advertising data from a printed page.

In certain embodiments of the electronic device 10, one or more accelerometers 38 may sense the movement or orientation of the electronic device 10. The accelerometers 38 may provide input or feedback regarding the position of the electronic device 10 to certain applications running on the CPU 12. By way of example, the accelerometers 38 may include a 3-axis accelerometer from ST Microelectronics.

FIGS. 2-5 illustrate various specific embodiments of the electronic device 10 of FIG. 1. It should be appreciated that the specific embodiments of the electronic device 10 depicted in FIGS. 2-5 are representative only and should not be understood as exclusive. Turning first to FIG. 2, a handheld device 40 may represent an embodiment of the electronic device 10 of FIG. 1. By way of example, the handheld device 40 may be a portable phone or a portable media player, such as an iPhone® or an iPod® available from Apple Inc.

The handheld device 40 may have an enclosure 41 of plastic, metal, composite materials, or other suitable materials in any combination. The enclosure 41 may protect the interior components of the handheld device 40 from physical damage and electromagnetic interference (EMI). Additionally, the enclosure 41 may allow certain frequencies of electromagnetic radiation to pass through to wireless communication circuitry within the handheld device 40 to facilitate wireless communication.

The display 18 of the handheld device 40 may include the user interface 20 in the form of a GUI, which may have a number of individual icons representing applications that may be activated. In some embodiments of the handheld device 40, the display 18 may serve as a touch-sensitive input device and the icons may be selected by touch. An online map application icon 42 may be selected by a user to launch an online map application. The online map application may display maps based on a searchable location or based on a current location of the handheld device 40 as determined by internal location sensing circuitry 22. As described below, the online map application may also display advertisements according to various techniques discussed herein. The user interface 20 may additionally include a web browser icon 43, the selection of which may launch a web browser such as Safari® by Apple Inc. The web browser may display content from the Internet including, among other things, advertisements provided according to techniques described herein.

An advertisement management application icon 44 may also be selectable by a user. Here, the advertisement management application is designated as “Local Ad +” to indicate to a user that selection of the icon 44 may allow the user to obtain, store, and/or view advertisements for local businesses and more. Similarly, a wireless network management application icon 45 may be selectable by a user. The wireless network management application icon 45 may launch a wireless network management application when selected, which may enable a user to manage connections to various nearby wireless networks and/or any information, such as advertisements, that may be transmitted over such wireless networks.

The user interface 20 on the display 18 of the handheld device 40 may also include certain status indicator icons 46, which may indicate the status of various components of the handheld device 40. For example, the status indicator icons may include a cellular reception meter, an icon to indicate when the PAN interface 28 is active (e.g., when a Bluetooth network is in use), or a battery life meter.

The handheld device 40 may connect to another electronic device 10, such as a computer, through the wired I/O interface 24 located at the bottom of the device. For example, the wired I/O interface 24 may be a proprietary connection for interconnecting the handheld device 40 and another electronic device 10 via USB or FireWire®. Once connected, the devices may synchronize and/or transfer certain data, such as advertisement data or data related to certain marketing factors. The wired I/O interface 24 on the handheld device 40 may be understood to represent a communication channel to another electronic device 10 for communication in accordance with techniques discussed herein.

User input structures 48, 50, 52, and 54 may supplement or replace the touch-sensitive input capability of the display 18 for interaction with the user interface 20. By way of example, the user input structures 48, 50, 52, and 54 may include buttons, switches, a control pad, keys, knobs, a scroll wheel, or any other suitable input structures. The user input structures 48 and 50 may work in conjunction with the display 18 to control functions of the device. Particularly, the user input structure 48 may be a lock/unlock sliding button to lock or unlock the handheld device 40; the user input structure 50 may be a navigation button for navigating the user interface 20 to a default or home screen; the user input structures 52 may be a pair of buttons for navigating up or down a screen of the user interface 20 or for controlling volume; and the user input structure 54 may be an on/off button.

Certain embodiments of the handheld device 40 may include telephone functionality. As such, the handheld device 40 may include audio input structures 56 and an audio output structure 58. The audio input structures 56 may be one or more microphones for receiving voice data from a user, and the audio output structure 58 may be a speaker for outputting audio data, such as data received by the handheld device 40 over a cellular network. In certain embodiments, an audio port 60 may facilitate peripheral audio input and output devices, such as headsets, speakers, or microphones for use with the handheld device 40. It should be appreciated that telephone functionality associated with the handheld device 40 may also include emitting a ringtone through the audio output structure 58, causing the handheld device 40 to vibrate, or changing images on the display to indicate an incoming phone call.

As noted above, some embodiments of the electronic device 10 may include the NFC interface 34. The handheld device 40 depicted in FIG. 2 may include the NFC interface 34 in any suitable location within the enclosure 41. Because the NFC interface 34 may permit communication at a very short range, the location of the NFC interface 34 in the handheld device 40 may be indicated on exterior of the enclosure 41, as illustrated in FIG. 2. The NFC interface 34 may enable the handheld device 40 to engage in near field communication (NFC) with RFID tags or other NFC enabled electronic devices 10. For example, the NFC interface 34 may provide a manner of receiving advertisement data from an RFID tag, as described further below.

The handheld device 40 of FIG. 2 may additionally include the camera 36, which may be located, for example, on the back of the handheld device 40. As discussed further below, the camera 36 may be used to obtain a digital image. The handheld device 40 may thereafter employ optical character recognition (OCR) software, barcode-reading software, or matrix-code-reading software to extract information from the image.

It should also be appreciated that the handheld device 40 may include the location sensing circuitry 22 or the accelerometers 38. Certain applications running on the handheld device 40 may obtain information relating to the position, orientation, or movement of the handheld device from the location sensing circuitry 22 or the accelerometers 38. The position, orientation, or movement information may enable applications to display personalized data or to display data in an innovative manner in response to user movement.

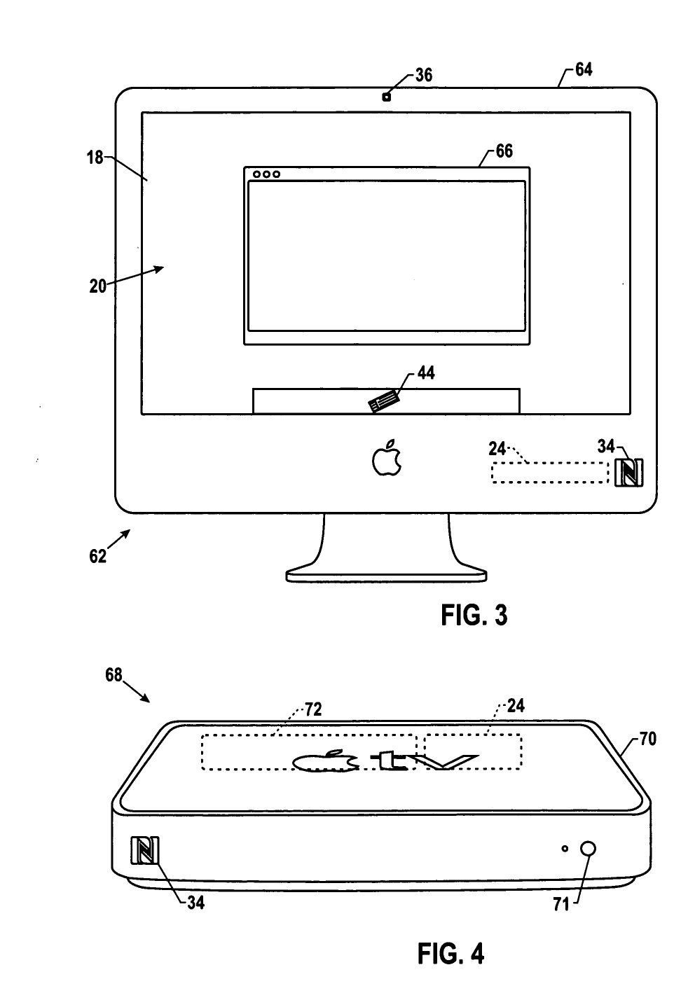

Turning to FIG. 3, a computer 62 may represent another embodiment of the electronic device 10 of FIG. 1. The computer 62 may be any computer, such as a desktop computer, a server, or a notebook computer, but may also be a standalone media player or video gaming machine. By way of example, the computer 62 may be an iMac®, a MacBook®, or an AppleTV® by Apple Inc. It should be noted that the computer 62 may also represent a personal computer (PC) or server computer by another manufacturer. An enclosure 64 may protect internal components of the computer 62. Such internal components may include, for example, the CPU 12, the main memory 14, the nonvolatile storage 16, certain network interfaces 26, and/or the NFC interface 34.

The location of the NFC interface 34 may be noted by a label on the exterior of the enclosure 64. The NFC interface 34 may permit near field communication between the computer 62 and other NFC enabled electronic devices 10, such as the handheld device 40. As should be appreciated, the NFC interface 34 may also enable the computer 62 to receive data from an RFID tag, as described further below.

The display 18 of the computer 62 may display the user interface 20 in the form of a GUI. The user interface 20 of the computer 62 may depict any user data associated with applications 66 running on the computer 62. Additionally, the user interface 20 may include a variety of icons related to applications installed on the computer 62. Such icons may include the online map application icon 42, the web browser icon 43, the advertisement management application icon 44, and the wireless network management icon 45. As should be appreciated, the selection of the above-described icons may launch corresponding applications on the computer 62. The computer 62 may additionally or alternatively include a dynamic advertisement pricing application, which may dynamically generate a price for an advertisement sent to a target user in accordance with techniques described below, or a dynamic advertisement selection application, which may determine an advertisement to send to a target user based on marketing factors previously supplied with regard to a previously-sent advertisement, as discussed below.

A user of the computer 62 may interact with the user interface 20 with various peripheral input devices, such as a keyboard or mouse, which may connect to the computer 62 via the wired I/O interface 24. The wired I/O interface 24 may also provide a high bandwidth communication channel for interconnecting other electronic devices 10, such as the handheld device 40, to the computer 62.

The computer 62 may also include the camera 36. As discussed further below, the camera 36 may obtain, among other things, a digital image. With the digital image, the handheld device 40 may employ optical character recognition (OCR) software, barcode-reading software, or matrix-code-reading software to extract information from the image.

FIG. 4 depicts a standalone media player 68 that may represent another embodiment of the electronic device 10 of FIG. 1 that may be configured to operate using the techniques described herein. By way of example, the standalone media player 68 may be an AppleTV® device by Apple, Inc. However, the standalone media player 68 may also represent a media player or video game console by another manufacturer.

Within an enclosure 70 of the standalone media player 68 may reside various components of the electronic device 10. For example, the enclosure 70 may house the nonvolatile storage 16 for storing media files and media playback software and the CPU 12 for processing the media files. Wireless network interfaces 26, such as the PAN interface 28 and LAN interface 30, may also be located within the enclosure 70, allowing the standalone media player 68 to communicate with other electronic devices 10 or to connect to the Internet. Using the wireless network interfaces 26, the standalone media player 68 may obtain or exchange media content as well as gain access to the Internet.

The standalone media player 68 may also include, among other things, an indicator light and infrared (IR) port 72 and audio/video (AN) outputs 74. The indicator light and IR port 72 may receive an IR control signal from a remote control and may indicate to a user when the standalone media player 68 is on, off, receiving or exchanging content, or obtaining data in accordance with techniques described herein. The A/V outputs 74 may provide a manner for connecting the standalone media player 68 to an analog or digital television or other media display devices. The standalone media player 68 may additionally include the wired I/O interface 24, which may permit the standalone media player 68 to communicate rapidly with a wired connection to another electronic device 10.

The standalone media player 68 may also include the NFC interface 34. With the NFC interface 34, the standalone media player 68 may communicate with another electronic device 10 having another NFC interface 34. Additionally, as described further below, the NFC interface 34 may also enable the standalone media player 68 to receive electronic data from an RFID tag, as described further below.

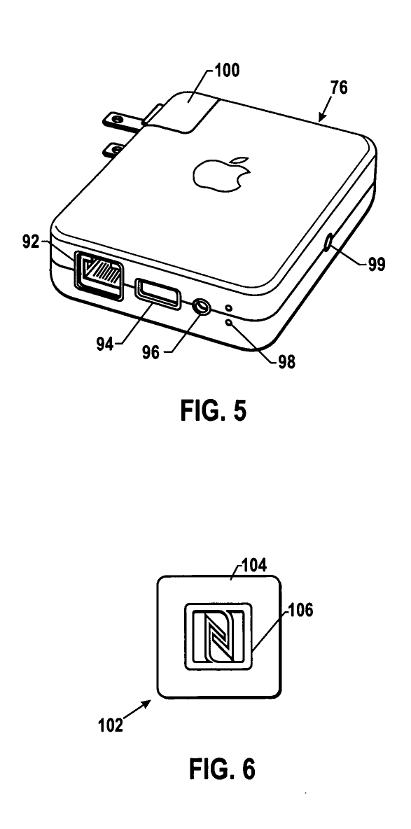

FIG. 5 illustrates an example of a base station 76 configured to provide wireless Internet access and/or to transmit wireless beacons containing electronic advertisements to an electronic device 10. By way of example, the base station 76 may be a model of an AirPort Express® available from Apple Inc. As described in greater detail below, an infrastructure owner or manager may employ the base station 76 to send wireless beacons with target advertisements to target users.

The base station 76 may include an Ethernet port 92, a USB port 94, a line out port 96, a reset button 98, and an AC plug adapter 100. The Ethernet port 92 may be a 10/100 Ethernet port 92 that may act as a connection interface between the base station 76 and an Ethernet device such as the computer 62, a cable modem, a DSL modem, an existing Ethernet network, etc. The base station 76 may also include a USB port 94. The USB port 94 may be used as a print server interface. As such, the USB port 94 may be used to connect the base station 76 to, for example, a printer compatible with the base station 76.

The base station 76 may also include a line out port 96. The line out port 96 may be an analog and optical digital audio stereo mini-jack, which may allow a home stereo or powered speakers to receive an audiovisual signal from another electronic device 10 via the base station 76. In this manner, the base station 76 may be used to stream music to a sound system belonging to a user. The base station 76 may further include a reset button 98. The reset button 98 may be used to troubleshoot and/or return the base station 76 to its factory settings. A status light 99 may inform a user of the working status of the base station 76.

The base station 76 may be powered by an AC plug adapter 100. The AC plug adapter 100 may be used to plug the base station 76 into an outlet. Additionally, the AC plug adapter 100 may be built directly into the base station 76, alleviating power cables and/or an external power adapter to power the base station 76. Additionally, the AC plug adapter 100 may retract into the housing of the base station 76 for ease of transport.

FIG. 6 illustrates an RFID tag 118 that may provide an electronic device 10 with additional information about a subject item to which it may be attached. The RFID tag 118 may adhere to the subject item, and may provide, among other things, advertisement information to the electronic device 10 that may be used to get additional information about the subject item. In an example described further below, the RFID tag 118 may be located on an historical marker. When the NFC interface 34 of a handheld device 40 is tapped to the RFID tag 118, the RFID tag 118 may provide data transferring information and an advertisement related to the historical marker or data indicating where information and an advertisement related to the historical marker may be obtained. Components of the RFID tag 118 may include, for example, an adhesive portion 120 and an RFID microchip 122.

The RFID microchip 122 may passively or actively transfer certain data related to the subject item to which it may be attached when the NFC interface 34 of the electronic device 10 is placed nearby (e.g., within 2-4 cm). Accordingly, the RFID microchip 122 may comply with such standards as ISO 14443 or ISO 15693 for proximity or vicinity RFID. To enable the electronic device 10 to gain additional information or advertisements about the subject item, the RFID microchip 122 may store data containing information and an advertisement related to the historical marker or data indicating where information and an advertisement related to the historical marker may be obtained. The information stored on the RFID microchip 122 may include, among other things, a serial number and/or an XML message having various information identifying the subject item to which the RFID tag 102 is attached. For example, the serial number may enable the electronic device 10 to search a database at a web service. Based on the serial number from the RFID microchip 122, the web service may provide information identifying the subject item and one or more advertisements related to the subject item. The XML message may provide similar information, such as the serial number and/or a location where such information or advertisements may be obtained.

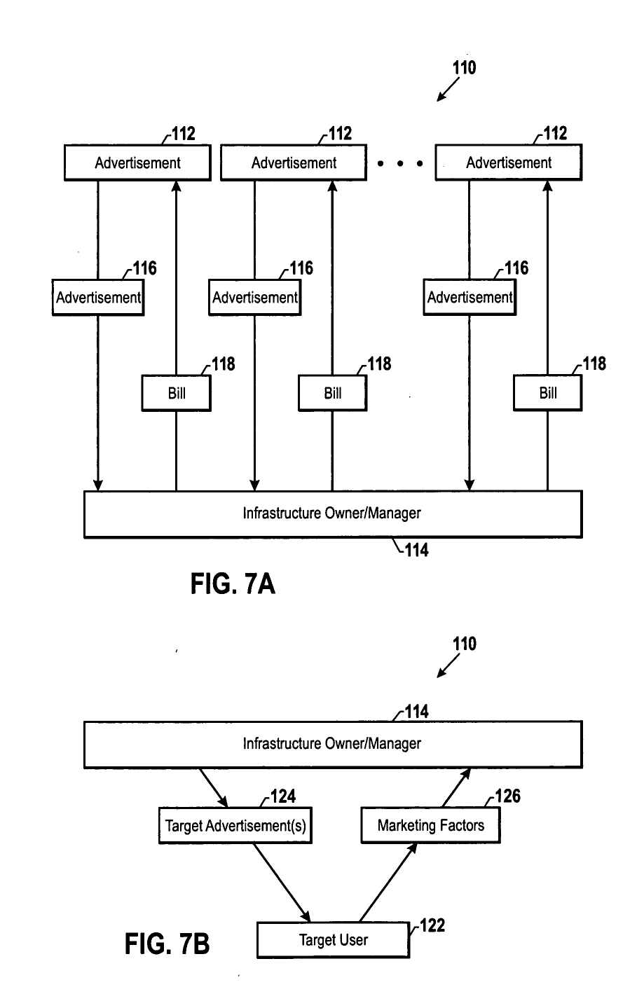

FIGS. 7A-B illustrate a dynamically-priced advertisement system 110, which may describe relationships between advertisers, an infrastructure owner or manager, and a user that may be the target of advertisements from the advertisers. Using the dynamically-priced advertisement system 110, an advertiser may a pay a unique price for an advertisement based on an assessment of characteristics unique to the target recipient. Turning first to FIG. 7A, the dynamically-priced advertisement system 110 may describe a relationship between a series of advertisers 112 and an infrastructure owner or manager 114. The infrastructure owner or manager 114 may represent any person, organization, or other entity with control over network infrastructure capable of transmitting advertisements to a target user, and the advertisers 112 may represent any person, organization, or other entity that may be granted the right to advertise by the infrastructure owner or manager 114.

By way of example, the infrastructure owner or manager 114 may be a municipality having a WiFi network and the advertisers 112 may be local businesses acting through a chamber of commerce; the infrastructure owner or manager 114 may be a private WiFi owner or publisher, which may accept advertisements from various local advertisers 112 in a manner analogous to a local printed advertising publication; the infrastructure owner or manager 114 may be a museum or airport providing network access to attendees, and the advertisers 112 may be lessees, tenants, or contractors affiliated with the airport or museum (e.g., a gift store, restaurant, or taxi/limousine service); the infrastructure owner or manager 114 may be a shopping mall or casino, and the advertisers 112 may be restaurants or shops located within the shopping mall or casino; the infrastructure owner or manager 114 may be any owner or manager of a publicly-accessible building providing network access to entrants; the infrastructure owner or manager 114 may be an owner or manager of a wireless broadband network, such as a 3G cellular network, and the advertisers 112 may be any person or entity to wishing to advertise over the wireless network; and/or the infrastructure owner or manager 114 may be a website, search engine, or Internet service provider (ISP), and the advertisers 112 may be any person or entity to submit web advertisements to the website, search engine, or ISP.

In the dynamically-priced advertisement system 110, the advertisers 112 may submit an electronic advertisement 116 to the infrastructure owner or manager 114. The electronic advertisement 116 may be any data intended to advertise to a target user. As such, the electronic advertisement 116 may be a text advertisement, a banner advertisement, a video, an interactive advertisement, and/or an electronic coupon. Concurrent with the submission of the advertisement 116, the advertisers 112 may provide information to the infrastructure owner or manager regarding the subject matter of the advertisement. For example, if the submitted advertisement 116 provides a coupon for food at a restaurant, the submitting advertiser 112 may include an indication that the advertisement 116 is directed to food sales, times of day when meals are popularly served, a GPS location of the restaurant, keywords that may relate to the restaurant in an Internet search, how weather may affect the use or non-use of the coupon in the advertisement 116, etc. As discussed further below, such additional information may be compared to various marketing factors associated with a target user to dynamically determine a price for each display of the advertisement 116.

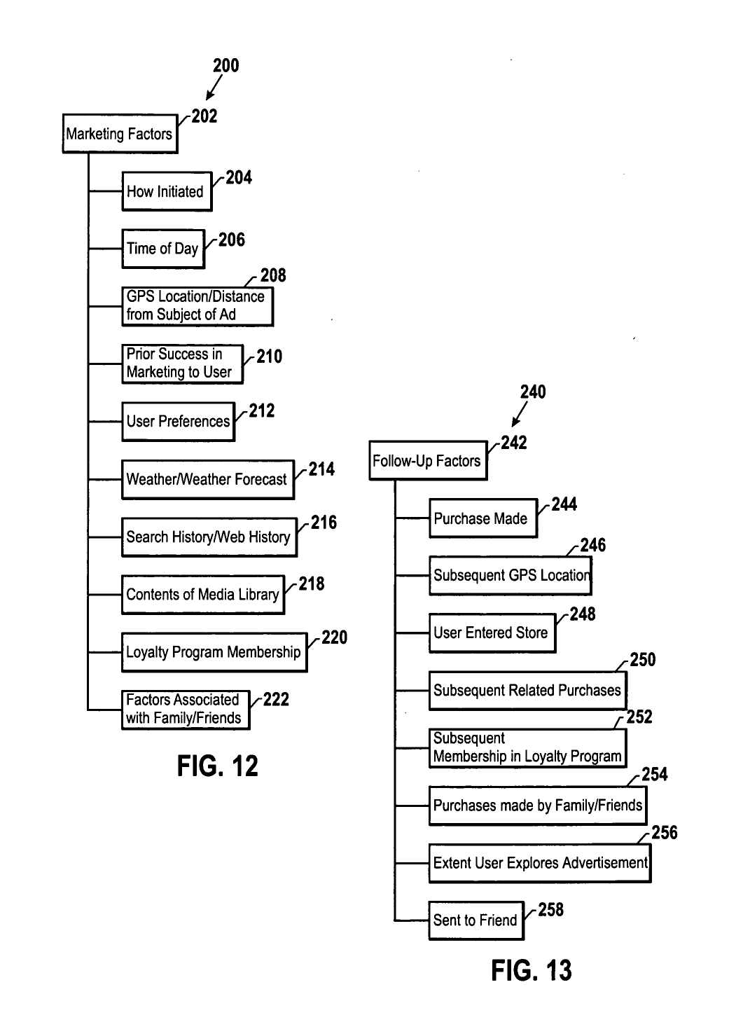

The infrastructure owner or manager may thereafter provide a bill 118 to the advertisers 112. As noted briefly above and discussed further below, the bill 118 may be generated dynamically by a dynamic advertisement pricing application on a computer 62 belonging to the infrastructure owner or manager. The dynamic advertisement pricing application may determine a price for sending each advertisement 116 to a target user based on factors discussed below with reference to FIGS. 12-13. The dynamically-generated prices billed for many advertisements 116 sent to users may be collated in each bill 118 and transmitted electronically to the advertisers 112, who may pay the bills 118 automatically and/or electronically.

FIG. 7B illustrates another relationship within the dynamically-priced advertisement system 110, which may include the infrastructure owner or manager 114 and a target user 122. The target user 122 may represent any person targeted by the infrastructure owner or manager 114 to receive one of the advertisements 116. By way of example, the target user 122 may be a user of a handheld device 40, a computer 62, or a standalone media player 68.

As noted above, the infrastructure owner or manager 114 may have previously received advertisements 116 from various advertisers 112. Choosing from among the various advertisements 116, the infrastructure owner or manager 114 may transmit selected target advertisements 124 to the target user 122 via network infrastructure under the control of the infrastructure owner or manager 114. The infrastructure owner or manager 114 may select which target advertisements 124 may be sent to the target user 122, for example, based upon a series of marketing factors 126 received from the target user 124, by randomly selecting target advertisements 124, and/or by electing to send all advertisements 116 as target advertisements 124.

The target user 122 may transmit the marketing factors 126 to the infrastructure owner or manager 114 before or after receiving the advertisements 124. The marketing factors 126 may represent a variety of variables that may be used to estimate the likelihood that the target user 122 may respond to the target advertisements 124, and may be described in greater detail below with reference to FIGS. 12-13. For example, the marketing factors 126 may indicate a time of day when the target user 122 receives the advertisements 124, the location of the target user 122 when the target user receives the advertisement, and/or whether the target user 122 responds to the advertisement 124 at a later time, etc.

It should be understood that if a target advertisement 124 is sent to the target user 122, and one or more marketing factors 126 is received in conjunction with the target advertisement 124, the marketing factors 126 may be applied to more narrowly tailor which target advertisement 124 is sent to the target user 122 in the future. For example, the computer 62 belonging to the infrastructure owner or manager 114 may include the dynamic advertisement selection application. Using the dynamic advertisement selection application, the infrastructure owner or manager 114 may select a subsequent to send to the target user 122 at a later time based on the previously received marketing factors 126. The subsequently-sent advertisement may be priced according to any model, including the dynamic pricing model discussed herein.

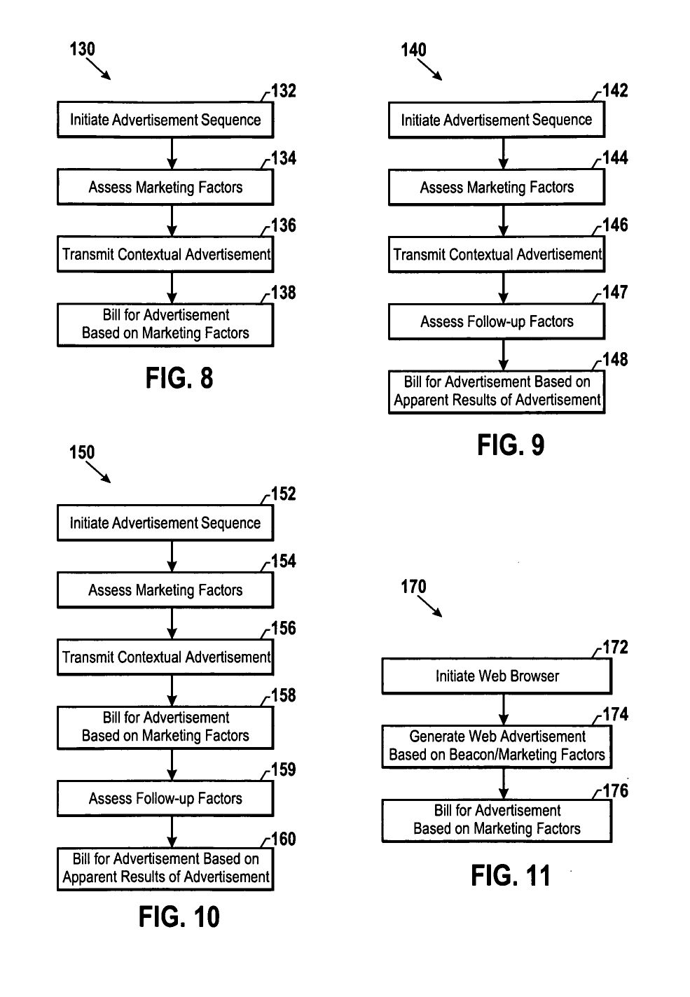

FIGS. 8-11 may generally describe various methods for providing dynamically-priced advertisements with the dynamically-priced advertisement system 110. It should be appreciated that each of the methods described by FIGS. 8-11 assumes that the infrastructure owner or manager 114 has already received advertisements 116 from various advertisers 112 in the manner shown in FIG. 7A. As such, the methods described by FIGS. 8-11 may focus on particular manners of sending and/or pricing the various target advertisements 124 that may be sent to a target user 122.

Turning first to FIG. 8, a flowchart 130 illustrates a manner of providing probability-based dynamically-priced advertisements with the dynamically-priced advertisement system of FIGS. 7A-B. In a first step 132 of the flowchart 130, an advertisement sequence may be initiated in a variety of ways. By way of example, as described in greater detail below, the advertisement sequence may be initiated when the infrastructure owner or manager 114 transmits an advertising beacon over a wireless network; when a user selects a button on an electronic device 10 such as a handheld device 40, computer 62, or standalone media player 68; when an RFID tag 102 is tapped to the NFC interface 34 of an electronic device 10; when a particular application is launched on an electronic device 10; and/or when a particular website is navigated to or search term is used in a search engine. In the initiation step 132, one or more marketing factors 126 may be sent from a target user 122 to the infrastructure owner or manager 114.

In a step 134, the infrastructure owner or manager 114 may assess the one or more marketing factors 126 that may have been sent by the target user 122 or otherwise obtained (e.g., a marketing factor such as location may be determined based on a location of a base station 76). In the assessment of step 134, the infrastructure owner or manager 114 may determine which advertisements 116 may be most pertinent to a target user 122 as a target advertisement 124, and/or may assess a probability that the target advertisement 124 may be effective. In one example described further below, the infrastructure owner or manager 114 may determine a target advertisement 124 to be an advertisement 116 for a restaurant based on marketing factors indicating that the user has made purchases at the restaurant in the past, the time corresponds with a common meal time, and the user is currently located near the restaurant.

Based on the assessment of step 134, the infrastructure owner or manager 114 may transmit a target advertisement 124 to the target user 122, as noted by step 136. It should be understood that step 136 may proceed prior to step 134, in which case the infrastructure owner or manager 114 may transmit a target advertisement 124 without first determining which advertisement 116 to select as the target advertisement 124. In such cases, the assessment of step 134 may take place after the target advertisement 124 has been sent to the target user 122, and the assessment of step 134 may be limited to assessing a probability that the target advertisement 124 may be effective in marketing to the target user 122, as discussed below.

In step 138, the infrastructure owner or manager 114 may provide a bill 118 for the target advertisement 124 that was sent to the target user 122 based on the probability that may be determined in step 134. A dynamic advertisement pricing application on a computer 62 belonging to the infrastructure owner or manager 114 may dynamically generate the bill 118. As such, the bill 118 may be dynamically determined according to the marketing factors 126 that may directly or indirectly indicate whether the target user 122 may likely be affected by the target advertisement 124. For example, the price for a target advertisement 124 directed to a restaurant may higher or lower depending on whether the target user 122 has eaten at the restaurant in the past, the time corresponds with a common meal time, and/or the target user 122 is currently located near the restaurant

FIG. 9 is a flowchart 140 describing a manner of providing results-based dynamically-priced advertisements with the dynamically-priced advertisement system of FIGS. 7A-B. Thus, while steps 142-146 of the flowchart 140 may function in substantially the same manner as steps 132-136 of the flowchart 130, steps 147 and 148 may vary. Particularly, steps 147 and 148 describe a dynamic pricing scheme that may consider various factors indicating a result of the target advertisement 124.

As noted above, steps 142-146 may function in substantially the same manner as steps 132-136 of the flowchart 130. Accordingly, in step 142, an advertisement sequence may be initiated, in step 144, various marketing factors 126 may be considered, and in step 146, a target advertisement 124 may be sent to a target user 122. As described above with reference to steps 134 and 136, steps 144 and 146 may occur in any order.

In step 147, various “follow-up” factors may be assessed by the infrastructure owner or manager 114. The follow-up factors are described in greater detail below with reference to FIG. 13, and may include, for example, whether the target user 122 responds to the target advertisement 124 by forwarding the target advertisement 124 to a friend, by later entering a store or location to which the target advertisement 124 pertained, and/or by utilizing an electronic coupon provided in the target advertisement 124. In step 148, the infrastructure owner or manager 114 may provide a dynamically-priced bill 118 to relevant advertisers 116 based on the assessment of step 147. As should be appreciated, the bill 118 may charge a higher or lower price based on indications provided by the follow up factors. For example, the bill 118 may be higher or lower depending on whether the target user 122 has used a coupon associated with the target advertisement 124, whether the target user 122 enters a place of business associated with the target advertisement 124, or whether the target advertisement 124 is forwarded by the target user 122 to another person.

Turning to FIG. 10, a flowchart 150 may describe a manner of providing both probability-based and results-based dynamically-priced advertisements with the dynamically-priced advertisement system of FIGS. 7A-B. As such, the flowchart 150 incorporates elements of dynamic pricing from the methods described in the flowchart 130 and the flowchart 140. Referring to the flowchart 150, steps 152-156 may substantially correspond to steps 132-136 of the flowchart 130 or 142-146 of the flowchart 140, step 158 may substantially correspond to step 138 of the flowchart 130, and steps 159 and 160 may substantially correspond to steps 147 and 148 of the flowchart 140. As such, in step 152, an advertisement sequence may be initiated; in step 154, various marketing factors 126 may be considered; in step 156, a target advertisement 124 may be sent to a target user 122; in step 158, a bill 118 for the target advertisement 124 may be provided based on a probability of the effectiveness of the target advertisement 124; in step 159, various follow-up factors may be considered; and in step 160, a bill 118 may be provided based on the effectiveness of the target advertisement 124. It should be appreciated that the bills 118 provided in steps 158 and 160 may be collated into a single bill 118 for all target advertisements 124 sent during a given time period, such as during one week or one month.

FIG. 11 is a flowchart 170 that may describe another manner of providing dynamically-priced advertisements with the dynamically-priced advertisement system 110 of FIGS. 7A-B. In a first step 172, an advertisement sequence may begin when a web browser application on an electronic device 10, such as Safari® on a handheld device 40, is launched or navigated to a website, such as a search engine. The web browser application may exchange various data with the website or with an intermediary network, which may represent infrastructure belonging to the infrastructure owner or manager 114. That data that may be exchanged may include various marketing factors and/or advertisement data corresponding to one or more target advertisements 124. In one example, the electronic device 10 may transmit various marketing factors, as discussed above with reference to the steps 132, 142, and 152 of the flowcharts 130, 140, 150. In another example, the electronic device 10 may have previously received advertisements according to the techniques described in the flowcharts 130, 140, or 150 above. As such, dynamic pricing for one or more target advertisements 124 sent to the target user 122, as discussed regarding steps 138, 148, 158, and/or 160, may provide a basis for selecting web advertisements to display.

Additionally or alternatively, if the electronic device 10 is within range of a base station 76, the base station 76 may have sent out one or more wireless beacons, which may include marketing factors or advertisement data corresponding to one or more target advertisements 124. The advertisement data may represent, for example, hypertext markup language (HTML) or extensible markup language (XML) files or pointers to one or more web locations from which advertisement data may be downloaded. The information may be stored on the electronic device 10 such that the electronic device 10 may send the information to the website or intermediary network, and may indicate, for example, a location of the user, which advertisements another infrastructure owner or manager 114 has selected for the user, whether a user has previously responded to a given advertisement, etc.

In step 174, the website or network infrastructure owner or manager may select a target advertisement 124 based on the data. The target advertisement 124 may represent a banner ad or other web advertisement, and may appear on the web browser among other, non-advertisement, data or among other non-targeted advertisements. In this way, the methods of the flowcharts 130, 140, or 150 may be extended to encompass targeted web advertising.

The flowchart 170 may additionally include a step 176 to determine a price for sending the target advertisement 124. In step 176, the infrastructure owner or manager 114 may dynamically determine the price based on the information assessed in step 174. As such, step 176 of the flowchart 170 may correspond to steps 138, 148, 158, or 160 of the flowcharts 130, 140, or 150 discussed above.

FIG. 12 illustrates a marketing factor diagram 200 listing a series of possible marketing factors 202 that may be assessed in steps 134, 144, or 154 of the flowcharts 130, 140, or 150. The marketing factors 202 represent factors that may be considered by the infrastructure owner or manager 114 using a dynamic advertisement pricing application on a computer 62 to determine a price for a dynamically-priced advertisement. The marketing factors 202 may represent data that may be stored on the electronic device 10, which may be transmitted from the electronic device 10 to a computer 62 belonging to the infrastructure owner or manager 114. It should be understood that the marketing factors 202 of the marketing factor diagram 200 are intended to be exemplary and not exclusive.

To determine a price for a given target advertisement 124, the infrastructure owner or manager 114 may assign a value to the various marketing factors 202 to calculate a total marketing probability of success for each target advertisement 124 sent to target user 122. As such, it should be understood that the value assigned to the various marketing factors 202 may vary based on the subject matter of the target advertisement 124. Depending on the calculated total marketing probability of success, the infrastructure owner or manager may determine a corresponding price for the target advertisement 124. By way of example, the marketing probability of success may be assessed based on three of the marketing factors 202 discussed below. Possible outcomes of the marketing factors 202 may be assigned various values (e.g., from 1-33). Depending on a sum of the values associated with the marketing factors 202 (e.g., a value totaling 3-99), the infrastructure owner or manager 114 may dynamically assign a price (e.g., $0.03 for a value totaling 3-35, $0.06 for a value totaling 36-67, or $0.10 for a value totaling 68-99). The precise value that may be associated with a given marketing factor 202 may generally correspond to the likelihood that a target user 122 may respond to a target advertisement 122. As such, it should be understood that such values may be experimentally determined or agreed upon by the advertisers 112 and the infrastructure owner or manager 114.

One marketing factor 202 that may be considered by the infrastructure owner or manager 114 may be a manner of initiation 204 of the dynamically-priced advertisement system 110. As noted above, an advertisement sequence may be initiated in a variety of ways, such as when the infrastructure owner or manager 114 transmits an advertising beacon over a wireless network; when a user selects a button on an electronic device 10 such as a handheld device 40, computer 62, or standalone media player 68; when an RFID tag 102 is tapped to the NFC interface 34 of an electronic device 10; when a particular application is launched on an electronic device 10; and/or when a particular website is navigated to or search term is used in a search engine. Depending on the nature of the target advertisement 124, a different value may be assigned to possible manners of initiation 204. For example, a target advertisement 124 sent following a user-initiated advertisement sequence may be assessed using a value corresponding to a higher price than a target advertisement 124 sent following a beacon-initiated advertisement sequence, since a user-initiated advertisement sequence may imply that the target user 122 is more receptive to receive the target advertisement 124.

Similarly, the infrastructure owner or manager 114 may consider the time of day 206 that the target advertisement 124 is sent to the target user 122 as a marketing factor 202. By way of example, if the target advertisement 124 pertains to a restaurant generally favored for lunch, a time of day 206 factor of morning and evening may be assigned a value corresponding to a lower price. Similarly, a time of day 206 factor of midday, when the target user 122 may likely go to lunch, may be assigned a value corresponding to a higher price.

A location 208 of the target user 122 when target advertisement 124 is sent may also serve as a marketing factor 202 to determine the price of the target advertisement 124. The location 208 may be determined by the location sensing circuitry 22 of the electronic device 10 receiving the target advertisement 124, or may be based on other indications, such as a location of a base station 76 which may send the target advertisement 124 or the ISP employed by the electronic device 10 to provide Internet access. Continuing with the above example, the target advertisement 124 may pertain to a restaurant having a particular location known to the infrastructure owner or manager 114. If the location 208 of the target user 122 is within a specified distance of the location of the restaurant, the location 208 factor may be assigned a value corresponding to a lower price. If the location 208 is beyond the specified distance of the location of the restaurant, the location 208 factor may be assigned a value corresponding to a higher price.

The infrastructure owner or manager 114 may also consider prior success 210 in marketing to the target user 122 as a marketing factor 202. Prior success 210 may signify that the target user 122 has responded to prior target advertisements 124 based on results of follow-up factors, which may be described in greater detail below with reference to FIG. 13. By way of example, the target advertisement 124 may pertain to a restaurant that may accept electronic coupons. If the target user 122 had previously used an electronic coupon at the restaurant, the prior success 210 factor may be assigned a value corresponding to a higher price. If not, the prior success 210 factor may be assigned a value corresponding to a lower price.

Certain user preferences 212 may also serve as a marketing factor 202 in the dynamic pricing assessment of the target advertisement 124. The user preferences 212 may be selected by the target user 122 of the electronic device 10 and may indicate whether the target user 122 may be receptive to the target advertisement 124. For example, the user preferences 212 associated with the target user 122 may include a preference to subscribe to certain email newsletters. If the user preferences 212 of the target user 122 are believed to increase the likelihood that the target user 122 may be receptive to the target advertisement 124, the user preferences 212 factor may be assigned a value corresponding to a higher price. If not, the user preferences 212 factor may be assigned a value corresponding to a lower price.

Depending on the weather or weather forecast 214, the target user 122 may alter their behavior. For example, in cold weather the target user 122 may prefer warm products, in warm weather the target user 122 may prefer cold products, in sunny weather the target user 122 may prefer to go outside, and in rainy weather the target user 122 may prefer to stay indoors. Thus, based on the weather or weather forecast 214, the infrastructure owner or manager 114 may assign a different price to the target advertisement 124, as described above. If the weather or weather forecast 214 is likely to improve the likelihood that the target user 122 may be receptive to the target advertisement 124, the weather or weather forecast 214 factor may be assigned a value corresponding to a higher price. If not, the weather or weather forecast 214 factor may be assigned a value corresponding to a lower price.

The infrastructure owner or manager 114 may also consider web history or search history 216 associated with the target user 122 in dynamically pricing the target advertisement 116. The web history or search history 216 may be sent to the infrastructure owner or manager 114 by the target user 122 among the various marketing factors 126, but may also be ascertained by the infrastructure owner or manager 114 in other ways. If the infrastructure owner or manager 114 provides Internet access to the target user 122, as may be the case if the infrastructure owner or manager 114 controls a wireless base station 76 with Wi-Fi or other wireless Internet access, the infrastructure owner or manager 114 may ascertain the web history or search history 216 of the target user 122 based on websites requested by the target user 122. Similarly, if the infrastructure owner or manager 114 operates a website or search engine, the infrastructure owner or manager 114 may ascertain the web history or search history 216 of the target user 122 based on the content of requested web pages or search terms input by the target user 122.

The web history or search history 216 associated with the target user 122 may enable the infrastructure owner or manager 114 to assess a likelihood that the target user 122 may respond to the target advertisement 124. For example, the web history or search history 216 associated with the target user 122 may indicate that the target user 122 has recently searched car-themed websites. If the target advertisement 124 advertises opportunities to purchase a new car, the web history or search history 216 of the target user 122 may increase the likelihood that the target user 122 may be receptive to the target advertisement 124. Accordingly, the web history or search history 216 factor may be assigned a value corresponding to a higher price. Otherwise, the web history or search history 216 factor may be assigned a value corresponding to a lower price.

Another marketing factor 202 may be based on the contents of a media library 218 belonging to the target user 122. For example, the media library of the target user 122 may include a large number of movies, music of a particular genre, or podcasts or television shows pertaining to certain topics. The existence or subject matter among the contents of the such media 218 may provide a reliable metric for estimating the efficacy of the target advertisement 124. By way of example, if the contents of the media library 218 of the target user 122 includes do-it-yourself television shows and the target advertisement 124 relates to home improvement, the contents of the media library 218 factor may be assigned a value corresponding to a higher price than if the television shows were not present among the contents of the media library 218.

Whether the target user 122 holds membership in a loyalty program 220 may also serve as a predictive marketing factor 202. As described herein, membership in a loyalty program 220 may represent, for example, membership in a frequent-flyer program, frequent-diner program, grocery store savings program, etc., that may indicate that the target user 122 is more likely to respond to the target advertisement 124. The infrastructure owner or manager 114 may gain knowledge of membership in a loyalty program 220 by being granted access to loyalty program databases controlled by the advertiser 112 supplying the target advertisement 124, or by receiving such information among the marketing factors 126 provided by the target user 122. By way of example, if the target user 122 holds membership in a loyalty program associated with an airline, and the target advertisement 124 advertises flights with the airline, the target user 122 may be more likely to be receptive to the target advertisement 124. Accordingly, the membership in a loyalty program 220 factor may be assigned a value corresponding to a higher price. Otherwise, the membership in a loyalty program 220 factor may be assigned a value corresponding to a lower price.

Because the target user 122 may make purchasing decisions based at least in part on the opinions or behavior of family or friends, the above-described marketing factors 202 as applied to family and friends 222 may also assist the infrastructure owner or manager 114 in determining a dynamic price for the target advertisement 124. In one example, prior success 210 in marketing to a friend of the target user 122 may imply a greater likelihood of success in marketing to the target user 122. In another example, the presence of a particular genre of movie among contents of a media library 218 belonging to a friend may imply a greater likelihood that a target advertisement 124 for the genre of movie may be successfully marketed to the target user 122.

The infrastructure owner or manager 114 may obtain data indicating the marketing factors 202 as applied to friends of the target user 122 in a variety of ways. The target user 122 may send information describing who represent friends or family of the target user 122, or the friends or family of the target user 122 may share an electronic device 10 that may store such factors. The infrastructure owner or manager 114 may determine friends or family of the target user 122 based on known connections on one or more social networking websites, and the marketing factors 202 as applied to the friends or family may be estimated based on publicly available information or private databases describing purchasing decisions, brand preferences, etc. As should be appreciated, the infrastructure owner or manager 114 may dynamically price a target advertisement 124 based on the marketing factors 202 as applied to family or friends 222 of the target user 122 in the manners described herein.

FIG. 13 illustrates a follow-up factor diagram 240 listing a series of possible follow-up factors 242 that may be assessed in steps 147 or 159 of the flowcharts 140 or 150. The follow-up factors 242 represent factors that may be considered by the infrastructure owner or manager 114 to determine a price for a dynamically-priced advertisement. It should be understood that the follow-up factors 242 may represent factors considered within a predetermined amount of time after a target advertisement 124 is sent to the target user 122 (e.g., within three hours or within one day). Moreover, the follow-up factors of the follow-up factor diagram 240 are intended to be exemplary and not exclusive.

To determine a price for a given target advertisement 124, the infrastructure owner or manager 114 may assign a value to the various follow-up factors 242 to calculate a total marketing success for each target advertisement 124 sent to target user 122. As such, it should be understood that the value assigned to the various follow-up factors 242 may vary based on the subject matter of the target advertisement 124. Depending on the calculated total marketing success, the infrastructure owner or manager may determine a corresponding price for the target advertisement 124. By way of example, the marketing success may be assessed based on three of the follow-up factors 242 discussed below. Possible outcomes of the follow-up factors 242 may be assigned various values (e.g., from 1-33). Depending on a sum of the values associated with the follow-up factors 242 (e.g., a value totaling 3-99), the infrastructure owner or manager 114 may dynamically assign a price (e.g., $0.03 for a value totaling 3-35, $0.06 for a value totaling 36-67, or $0.10 for a value totaling 68-99). The precise value that may be associated with a given follow-up factors 242 may generally correspond to the degree to which the target user 122 has responded to a target advertisement 122. As such, it should be understood that such values may be agreed upon by the advertisers 112 and the infrastructure owner or manager 114.

One follow-up factor 242 that may be considered by the infrastructure owner or manager 114 may be whether a purchase is made 244 by the target user 122 after receiving the target advertisement. The infrastructure owner or manager 114 may ascertain whether the target user 122 has made a purchase in a variety of ways. For example, the infrastructure owner or manager 114 may receive such an indication directly from the target user 122 or from the advertiser 112 that supplied the target advertisement 124, if the target user 122 makes a purchase from the advertiser 112. If the target user 112 makes a purchase 244 following the receipt of the target advertisement 124, the factor 244 may be assigned a value corresponding to a higher price. If not, the factor 244 may be assigned a value corresponding to a lower price.

Even if the target user 122 does not make a purchase 244 within the predetermined time, the target user 122 may provide other indications that the target advertisement 124 was successful. For example, a subsequent location 246 of the target user 122 may indicate that the target user 122 has been influenced by the target advertisement 124. After receiving a target advertisement 124, the target user 122 may approach a store or restaurant to which the target advertisement 124 pertains. If the target user 122 approaches, but does not enter, the store or restaurant advertised in the target advertisement 124, the target advertisement 124 may have influenced the target user 122. For such a condition, the infrastructure owner or manager 114 may assign a value corresponding to a higher price to the subsequent location 246 factor.

The infrastructure owner or manager 114 may further assess whether the target user 122 enters a store or restaurant 248 after receiving a target advertisement 124 advertising the store or restaurant. That the target user 122 enters the store or restaurant 248 may imply that the target advertisement 124 influenced the target user 122. Accordingly, the infrastructure owner or manager 114 may assign to the factor 248 a value corresponding to a higher price if the user enters the store or restaurant. If the user does not, the infrastructure owner or manager 114 may assign to the factor 248 a value corresponding to a lower price.

After receiving the target advertisement 124, the target user 122 may not make a purchase directly related to the target advertisement 124 to fulfill the factor 244. However, the target user 122 may make related purchases 250 from the same advertiser 112, may choose to gain membership in a loyalty program 252 of the advertiser 112, and/or family or friends may make related purchases 254. The infrastructure owner or manager 114 may consider whether or not such circumstances may occur in determine the dynamic price of the target advertisement 124 by varying the values associated with each of the factors 250, 252, and/or 254 as appropriate.

The extent to which the target user 122 explores 256 the target advertisement 124 may further indicate whether the target advertisement 124 has succeeded in marketing to the target user 122. Thus, for example, if the target user 122 elects to seek further information regarding the target advertisement 124, the infrastructure owner or manager 114 may assign a value corresponding to a higher price to the factor 256. Similarly, that the target user 122 may forward 258 the target advertisement 124 to a friend may also indicate the efficacy of the target advertisement. Accordingly, the infrastructure owner or manager 114 may assign a value corresponding to a higher price to the factor 258.

The factors discussed above with reference to FIGS. 12-13 may be marketed to potential advertisers 112 and/or infrastructure owners or managers 114 by advertising agencies or other promoters. The advertising agencies may market an advertisement pricing scheme with dynamically-generated advertisement pricing in the manners described above. To do so, the advertising agency may recommend a type of advertisement (e.g., a restaurant advertisement), various marketing factors (e.g., time of day 206, location 208, prior success 210, weather 214, etc.), and a weighting scheme for each factor (e.g., the time of day 206 factor may vary between a maximum value at lunchtime to a minimum value after dinnertime when the restaurant has closed) to dynamically set a price for each time the advertisement is sent to a target user 122.

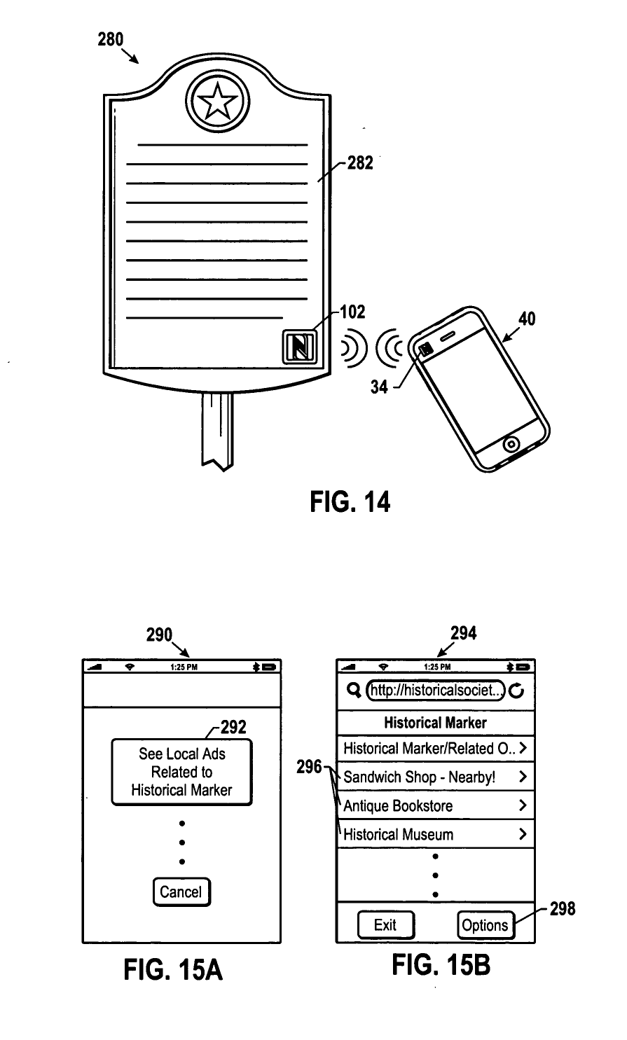

FIGS. 14-16 illustrate an example of carrying out the above-described methods. Though FIGS. 14-16 exemplify using the techniques described above with the handheld device 40, it should be appreciated that alternatively any electronic device 10 may be employed. Turning first to FIG. 14, a RFID tag-scanning operation 280 represents a manner a user may seek to gain additional information from a particular subject by receiving information via an RFID tag 102. In so doing, the RFID tag-scanning operation 280 may represent one manner of initiating an advertisement sequence, and thus may represent steps 132, 142, or 152 of the flowcharts 130, 140, or 150.

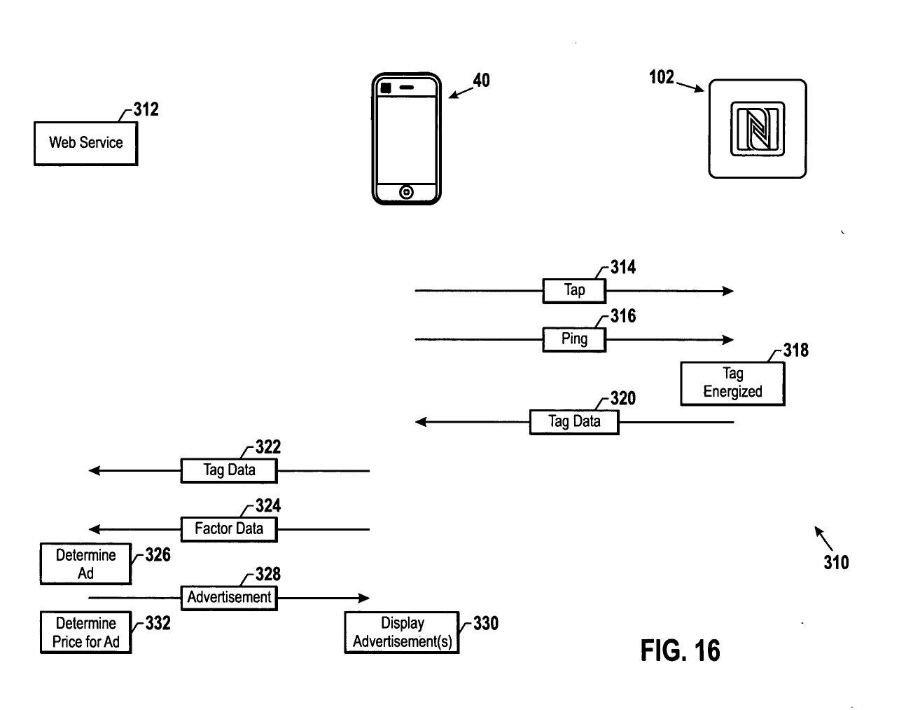

In the example of FIG. 14, the RFID tag 102 may be located on an historical marker 282. To learn more about the historical marker 282 and retrieve various advertisements that may be related to the historical marker 282, the user may tap a handheld device 40 to the RFID tag 102. The RFID tag 102 may thereafter communicate various information to the handheld device 40 by way of a near field communication (NFC) channel, as discussed below with reference to FIG. 16.

Turning to FIGS. 15A-B, after tapping the RFID tag 102 to the handheld device 40, the handheld device 40 may display a screen 290, as shown in FIG. 15A. The screen 290 may include a prompt 292, among other related prompts. The prompt 292 may be labeled “See local ads related to historical marker,” which may allow a user to further explore the historical marker. If the user selects the button 292, the handheld device 40 may display a screen 294, as shown in FIG. 15B. The screen 294 may include a series of list items 296, which may represent various local advertisements related to the historical marker 282. The screen 294 may further include a button 298, labeled “Options.” The button 298 may enable a user to sort the list items 296 with such preferences as nearest location, greatest percent discount, whether the advertisement relates to food or other products, etc.

Turning to FIG. 16, a communication diagram 310 illustrates communication that may take place during the RFID tag-scanning operation 280. As illustrated in the communication diagram 310, communication may take place among a web service 312 (e.g., a computer 62 configured to communicate over a network with the handheld device 40), the handheld device 40, and the RFID tag 102. Communication may begin as the handheld device 40 taps the RFID tag 102, as shown by block 314. Because the NFC interface 34 of the handheld device 40 may periodically emit a near field communication ping 316, the RFID tag 102 may receive the ping 316. Upon receiving the ping 316, the RFID tag 102 may become energized, as illustrated by block 318.

After becoming energized, the RFID tag 102 may reply with tag data, as shown in block 320, which may represent data that may be stored on the RFID tag 102. The tag data of the block 320 may be any data calculated to provide information about the RFID tag 102. For example, the tag data 320 may represent a serial number, an XML file, or other file with various identifying information, etc., which may enable the handheld device 40 to obtain additional information about the subject of the RFID tag 102 from another source, such as the web service 312.

The handheld device 40 may send the tag data received in the block 320 to the web service 312, as shown in block 322. Moreover, the handheld device 40 may transmit various marketing factors 126, denoted as factor data in a block 324, which may represent information relating to various marketing factors 202 as determined by the handheld device 40. Using the tag data of the block 322 and the factor data of the block 324, the web service 312 may determine an appropriate target advertisement 124, as illustrated in block 326. Accordingly, it should be understood that the determination of block 326 may represent, at least in part, the step 134, 144, or 154 of the flowcharts 130, 140, or 150 discussed above.

The web service 312 may subsequently transmit one or more target advertisements 124 to the handheld device 40, as shown by a block 328. The communication of the block 328 may represent, at least in part, the steps 136, 146, or 156 of the flowcharts 130, 140, or 150. The handheld device 40 may store or display the target advertisement 124, as illustrated in block 330. Such advertisements may include those that may appear on the screen 294 of FIG. 15B. Meanwhile, the web service 312 may determine a price for the target advertisement 124 sent in block 328, as illustrated in block 332.

The web service 312 may calculate a price for each of the one or more target advertisements 124 in block 332 based on the factor data of block 324 and the subject matter of each target advertisement 124. Using the example discussed in FIG. 15B, the exemplary target advertisements 124 may advertise the “Sandwich Shop,” an “Antique Bookstore,” and/or a “Historical Museum.” To best assess the efficacy of the target advertisements 124, the various factors 202 of block 324 may include, for example, the time of day 206 when the advertisement 124 was sent in block 328; the user location 208, as determined by the tag data from block 322 or from the location-sensing circuitry 22 of the handheld device 40; and/or a search history or web history 216 from the handheld device 40.

To determine a price for the targeted advertisement 124 advertising the “Sandwich Shop,” the web service 312 may consider the time of day 206. If the time of day 206 is 11:30 a.m., the advertisement 124 may be priced at $1.00, but if the time of day 206 is 2:30 p.m., the advertisement 124 may be priced at $0.50. Similarly, to determine a price for the targeted advertisement 124 advertising the “Historical Museum” or the “Antique Bookstore,” the web service 312 may consider the time of day 206 and the user location 208. If the time of day 206 indicates that the museum and bookstore are open and the location 208 indicates that the target user 122 is nearby, the advertisement 124 may be priced at $4.00, but if the time of day 208 indicates that the museum and bookstore are closed and the location 208 indicates the user is far away, the advertisement 124 may be priced at $0.75.

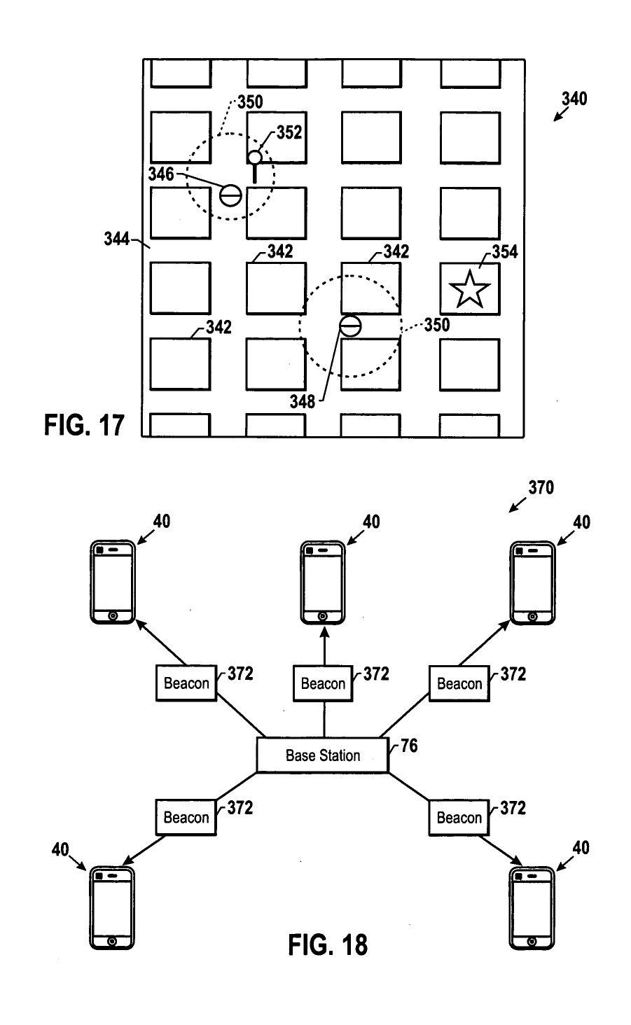

FIGS. 17-21 may represent another example of the techniques described above. Turning first to FIG. 17, a schematic of a city plan 340 may illustrate a manner in which an infrastructure owner or manager 114 may transmit target advertisements 124 to one or more target users 122. The city plan 340 may illustrate buildings 342 surrounded by streets 344. In the city plan 340 of FIG. 17, a municipal or regional transit authority may run various subway stations throughout the city. As such, the city plan 340 may schematically illustrate a first subway station 346 and a second subway station 348.

The transit authority may provide Internet access and/or wireless advertisements to patrons of the subway stations 346 and 348, and thus may serve as an infrastructure owner or manager 114 having a capability to send target advertisements 124 to one or more target users 122. In the example of FIG. 17, the first subway station 346 and the second subway station 348 may be outfitted with one or more wireless base stations 76. The limited range of the one or more wireless base stations 76 that may be located at the subway stations 346 and 348 may be illustrated with a wireless data radius 350 that may be generally surround the entrances to the subway stations 346 and 348. Additionally, it should be understood that the range of the one or more wireless base stations 76 may extend within the subway stations 346 and 348. Moreover, any other transportation centers controlled by the transit authority may additionally include the capabilities of the subway stations 346 and 348.

When a user of an electronic device 10 enters within the wireless data radius 350 of either of the subway stations 346 or 348, such as a user location 352, the one or more wireless base stations 76 may transmit a beacon to the electronic device 10. The beacon may include various data, including advertisement data that may represent one or more target advertisements 124 of the dynamically priced advertisement system 110. For exemplary purposes, a target location 354 may represent a location of a store or restaurant that may be the subject of the target advertisement 124 sent to the target user 122 at the user location 352.

Turning to FIG. 18, a beacon transmittal diagram 370 illustrates a manner in which an infrastructure owner or manager 114 controlling a wireless base station 76 may reach target users 122 having a handheld device 40. In the diagram 370, the base station 76 may transmit a wireless beacon 372 to any number of handheld devices 40. The base station 76 may be in any location, such as the first or second subway stations 346 or 348. The data transmitted by the beacon 372 may be received by the handheld device 40 and used in a variety of ways. For example, the beacon 372 may include a web archive file representing a target advertisement 124 or may represent a link to a website where the target advertisement 124 may be obtained.

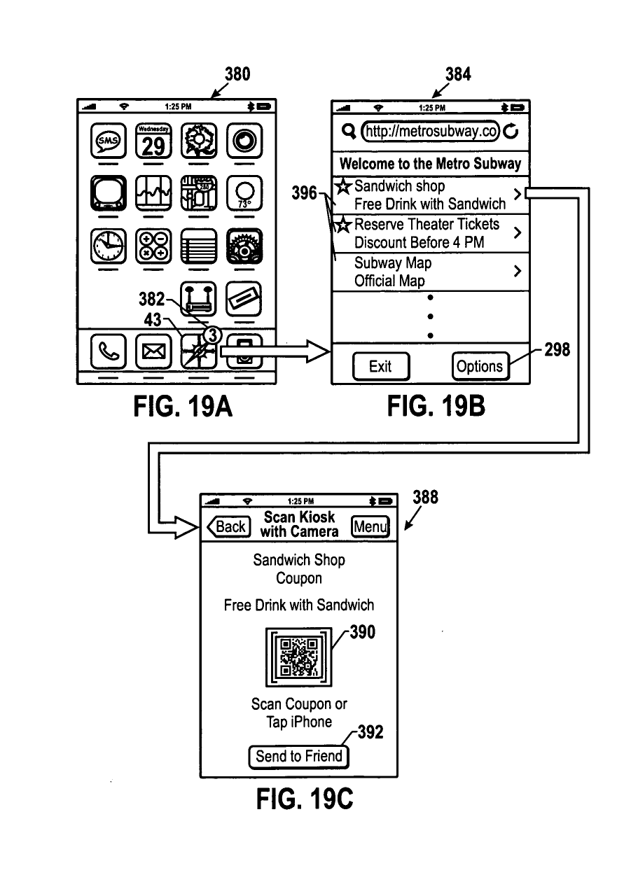

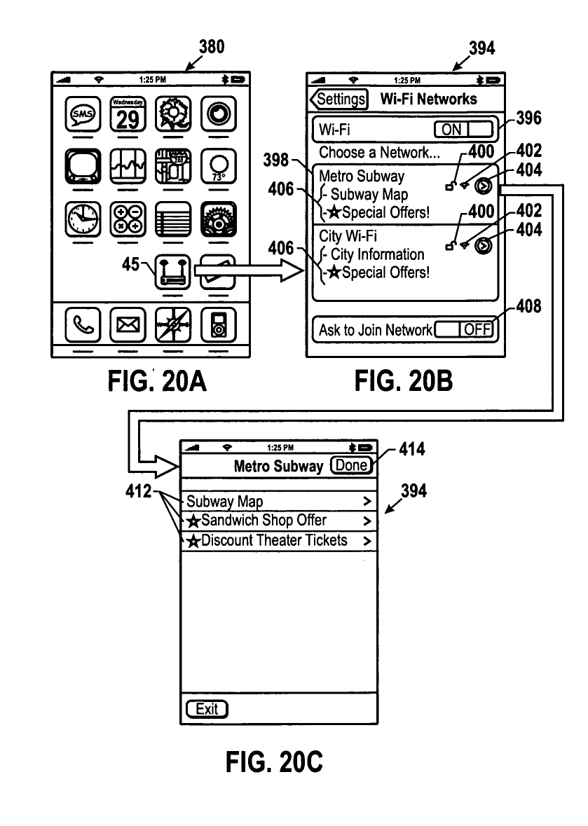

When the wireless beacons 372 reach one of the handheld devices 40, the handheld devices 40 may display various notification icons, as described below with reference to FIGS. 19-20. Such notification icons present a user with the opportunity to view items of potential interest. For example, a notification icon may appear as a bubble over the web browser application icon 43 when a user is in range of the base station 76 broadcasting content wireless beacons 372. Alternatively, the handheld device 40 may ring in a certain manner, emit a tone, or vibrate to alert the user that a wireless beacon 372 may be providing information of potential interest. Additionally or alternatively, the wireless beacon 372 may supply additional information regarding an accessible wireless network provided by the wireless base station 76.

FIGS. 19A-C illustrate an exemplary response by the handheld device 40 upon receiving a beacon 372 from the base station 76 when the beacon 372 includes various advertisement data, such as one or more target advertisements 124. Turning first to FIG. 19A, a home screen 380 may include a variety of icons for initiating various applications. As shown in FIG. 19A, the web browser application icon 43 of the home screen 380 may include a message notification icon 382. The message notification icon 382 may denote that messages may have been received in a wireless beacon 372 from a nearby base station 76.

If a user selects the web browser icon 43, the handheld device 40 may display a screen 384, as shown in FIG. 19B. The screen 384 may represent a web archive file received in the beacon 372 or may represent a website displayed from a link received by the beacon 372. As illustrated on the screen 384, a series of list items 386 may represent various information provided via the beacon 372. Continuing with the example illustrated in FIG. 17, the beacon 372 may have transmitted information indicating, for example, a link to a subway map, and a link to various target advertisements 124. One such target advertisement 124 may advertise a sandwich shop that may be located at the target location 354. Another target advertisement 124 may advertise reserving theatre tickets over the Internet.

If the user selects the list item 386 advertising the sandwich shop, the handheld device 40 may retrieve additional information from the Internet or may load additional information from a web archive file received from the beacon 372. Upon selecting the list item 386 advertising the sandwich shop, the handheld device 40 may display a screen 388, as illustrated in FIG. 19C. The screen 388 may represent, for example, a coupon for a free drink with the purchase of a sandwich at a restaurant called “Sandwich Shop.” The screen 388 may include, for example, a matrix barcode 390 encoding a serial number to obtain the stated discount. A button 392, labeled “Send to Friend,” may enable a user to forward the advertisement to another friend while simultaneously informing the infrastructure owner or manager 114 that such action has been taken by contacting the base station 76 or an affiliated web service 312. In addition to providing the matrix barcode 390, the handheld device 40 may also prepare to transfer the same information encoded in the matrix barcode 390 via near field communication if the user taps the NFC interface 34 of the handheld device 40 to a kiosk or cash register configured to receive such information.

FIGS. 20A-C illustrate another exemplary response by the handheld device 40 upon receiving a beacon 372 from the base station 76. Turning first to FIG. 20A, the home screen 380 may be displayed on the handheld device 40. The user may select the wireless network management application icon 45, which may launch the wireless network management application. Alternatively, it should be understood that the features of the wireless network management application may form a portion of an operating system that may run on the handheld device 40. As such, the features of the wireless network management application described herein may be accessible by way of a general settings menu.

Selecting the wireless network management application icon 45 may cause the handheld device 40 to display a screen 394, as illustrated in FIG. 20B. The screen 394 may include, for example, a selection button 396 to enable or disable receipt of wireless transmissions over 802.11x wireless networks. A network selection box 398 may list various wireless networks that may be accessible via one or more base stations 76 within range of the handheld device 40. Within the box 398, an icon 400 may indicate whether the particular network is secure, an icon 402 may indicate the strength of the network, and an icon 404 may allow a user to view additional information regarding the particular network. Also within the box 398 may be various information transmitted via the beacon 372, which may include, for example, one or more target advertisements 124.

Selecting one of the icons 404 pertaining to a network on the screen 394 may cause the handheld device 40 to display a screen 410, as illustrated in FIG. 20C. The screen 410 may include various list items 412 that may provide links to additional information in the same manner as the screen 384 of FIG. 19B. The user may select any of the list items 412 to view additional information on the listed topic, such as various target advertisements 124. In the example of FIG. 20C, one target advertisement 124 may advertise a sandwich shop that may be located at the target location 354, while another target advertisement 124 may advertise reserving theatre tickets over the Internet. By selecting a button 414, labeled “Done,” the user may return to the screen 394, as illustrated in FIG. 20B.

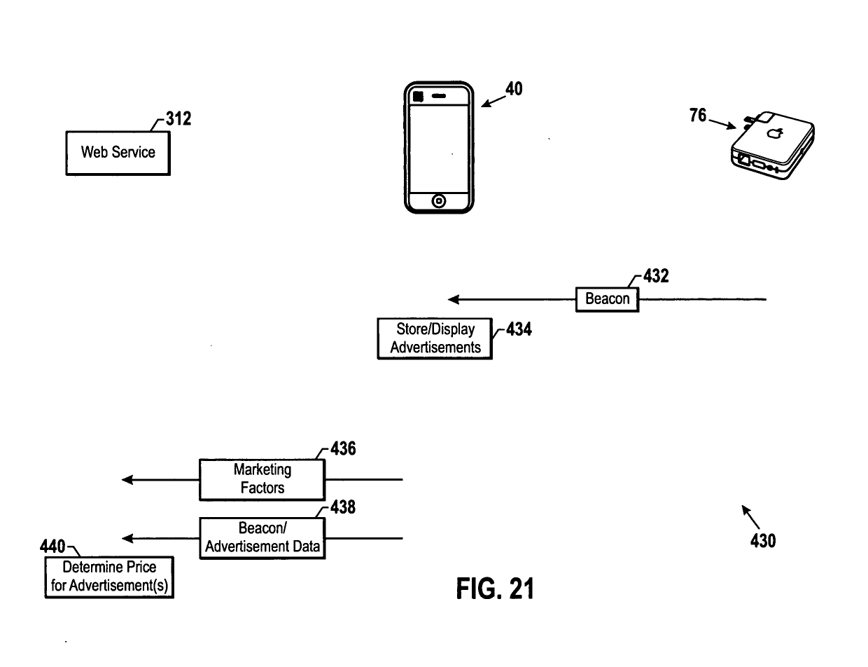

FIG. 21 illustrates a communication diagram 430 describing communication between the handheld device 40, the base station 76, and the web service 312 that may take place when the handheld device receives a beacon 372 from the base station 76. It should be appreciated that the web service 312 and the base station 76 may both be subject to control by the infrastructure owner or manager 114 or may be owned by another entity sharing them by agreement with the infrastructure owner or manager 114. The communication illustrated in the communication diagram 430 may begin when the base station 76 transmits a wireless beacon 372 to the handheld device 40, as shown in block 432. The handheld device 40 may next store or display the information retrieved from the beacon 372 from the block 432 in the manner described above with reference to FIGS. 19-20. Such storing and displaying of information may include storing and displaying one or more target advertisements 124, as described above. A block 436 illustrates that various marketing factors 202 may be sent from the handheld device 40 to the web service 312 concurrently with data indicating which data indicating that the handheld device 40 has received the target advertisements 124 from the beacon 372 of the block 432. Such information may also be transmitted when a user chooses to view a target advertisement 124 in greater detail, as may be generally described as selecting from among the list items 412 of FIG. 20C or list items 386 of FIG. 19B.

As illustrated in block 440, the web service 312 may subsequently determine the price for the one or more advertisement of the target advertisements 124. In determining the price for the one or more target advertisements 124, the web service 312 may employ the marketing factors 202 and/or various follow up factors 242 that may be received by the web service 312 from the handheld device 40 or from another source. Another source may include, for example, the advertiser 112 that may be the subject of the target advertisement 124. By way of example, after the user of the handheld device 40 receives the target advertisement 124 for the sandwich shop, indicated as among the list items 386 or 412, the target user 122 may take the first subway station 346 to the second subway station 348. In so doing, the target user 122 may have moved closer to the target location 354 of the sandwich shop. When the handheld device 40 receives a beacon 372 from the second subway station 348, the handheld device 40 may note that the user 122 has changed locations and may so indicate to the web service 312. Accordingly, the follow up factors 242 may indicate that the subsequent location 246 of the user has approached more closely to the target location 354.

Similarly, if the user ultimately enters the sandwich shop at the target location 354, fulfilling the follow-up factor 248, and then makes a purchase, fulfilling the follow-up factor 244, the web service 312 may calculate a higher price for the target advertisement 124. That the user has entered the store may be relayed to the web service 312 by way of the handheld device 40. Similarly, if the target user 122 to which the handheld device 40 belongs uses the electronic coupon of FIG. 19C to purchase a sandwich at the sandwich shop, the sandwich shop owner may supply information regarding the purchase to the web service 312.

The web service 312 may calculate a price for each of the one or more target advertisements 124 in block 440, based on the factor data of block 436 and the subject matter of each target advertisement 124. Using the example discussed above, the web service 312 may assign a price of $0.10 if the user does not approach the target location 354, enter the store, or make a purchase; of $0.25 if the user fulfills one of the factors; of $0.50 if the user fulfills two of the factors; and/or of $1.00 if the user fulfills all three of the factors.

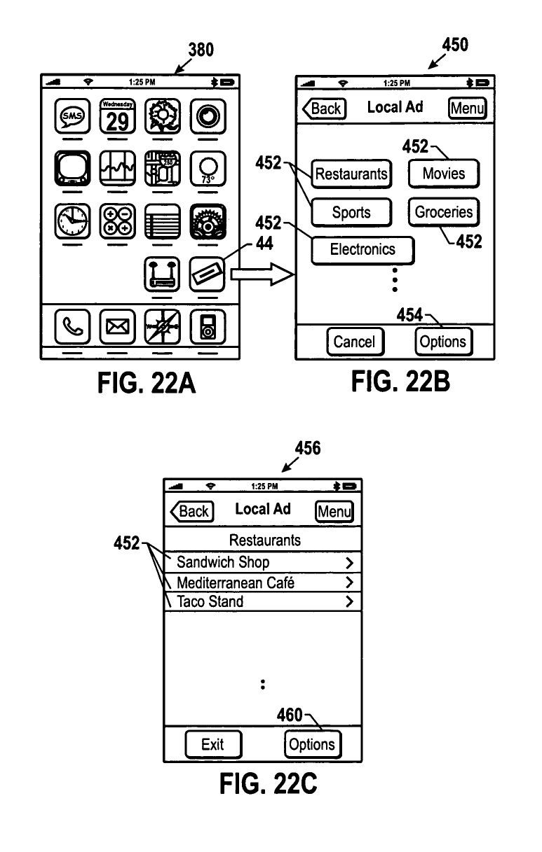

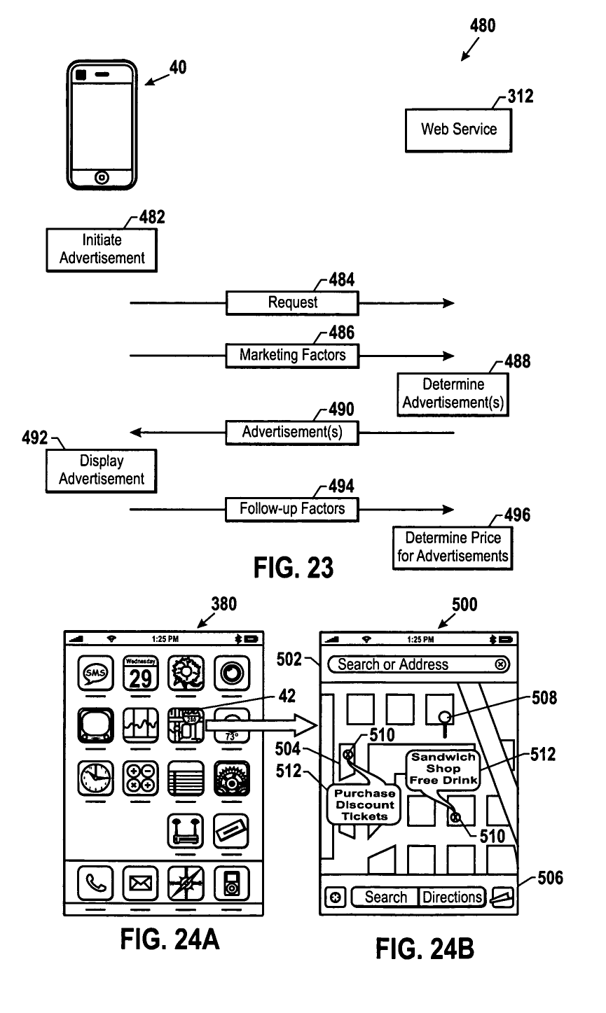

FIGS. 22-23 provide an example of performing the method of the flowchart 150 of FIG. 10. Turning first to FIG. 22A, a user may select the advertisement management application 44 from the home screen 380. Selecting the advertisement management application 44 may represent step 152 of the flowchart 150, initiating an advertisement sequence. In response, the handheld device 40 may display a screen 450, as illustrated in FIG. 22B. The screen 450 may represent a main menu screen to the advertisement management application that may run on the handheld device 40. The screen 450 may include a series of categories 452 of advertisements for various local products and services. As such, the categories 452 may include, for example, “Restaurants,” “Movies,” “Sports,” “Electronics,” “Groceries,” etc. A button 454, labeled “Options,” may enable a user to vary different settings for display of different advertisements. By way of example, such options may include a distance from a user's current location over which to consider an advertisement local or a preference for certain types of products or services, such as certain genres of movies, etc.

If a user selects the category 452 labeled “Restaurants,” the handheld device 40 may display a screen 456, as illustrated in FIG. 22C. The screen 456 may include a series of list items 458, representing offers available from various restaurants as retrieved from an Internet location, such as the web service 312. The screen 456 may also include a button 460, labeled “Options.” The button 460 may allow a user to set various preferences, including, for example certain styles of food preferred, pricing preferences, whether the target advertising 124 includes a coupon, etc.

FIG. 23 illustrates a communication diagram 480, which may describe communication between the handheld device 40 and the web service 312 that may take place in the example of FIGS. 22A-C above. In the communication diagram 480, a user may initiate an advertisement sequence, as illustrated by a block 482, when the user selects the advertisement management application icon 44, and selects a particular genre. The handheld device 40 may transmit a request, as shown in block 484, along with various marketing factors 202, as shown in block 486, to the web service 312. It should be understood that the communication taking place during the blocks 482-486 may represent steps 132, 142, or 152 of the flowcharts 130, 140, or 150.

The web service 312 may determine which advertisements to send as target advertisements 124 to the handheld device 40. The determination of block 488 may be generally understood as analogous to the steps 134, 144, or 154 of the flowcharts 130, 140, or 150. As shown by block 190, the web service 312 may transmit one or more target advertisements 124 based on the determination of block 488. The handheld device 40 may subsequently display a list of the target advertisements as shown in block 492. After a predetermined amount of time, the handheld device 40 may transmit various follow up factors 242, as shown by block 494. The web service 312 may additionally or alternatively obtain follow-up factors 242 from another source, such as a restaurant that may be the subject of the target advertisements 124. Using the marketing factors 202 and the follow up factors 242, the web service 312 may determine a price for the one or more target advertisements 124, as shown by block 496. It should be understood that the dynamic determination of the price of the target advertisements 124 may take place using the techniques described above.

FIGS. 24A-B illustrate receiving one or more target advertisements 124 via a mapping application on the handheld device 40. Turning first to FIG. 24A, a user may select the on-line map application icon 42 of the home screen 380. Upon the selection of the icon 42, the handheld device 40 may launch the on-line map application, and may display a screen 500, as illustrated in FIG. 24B. In the screen 500, a search for address bar 502 may enable a user to search a map currently in view on a main map screen 504. A navigation bar 506 may enable a user to change various options related to the map, including, for example, whether the map is a street map or a satellite view of the map. A user location 508 may indicate the current location of the user of the handheld device 40 on the map screen 504. Locations affiliated with local advertisers 112 may be denoted as advertising locations 510. Various target advertisements 124 may be displayed in advertisement bubbles 512 connected to the advertising locations 510. Selecting the advertising bubbles 512 may cause a more detailed advertisement to be displayed.

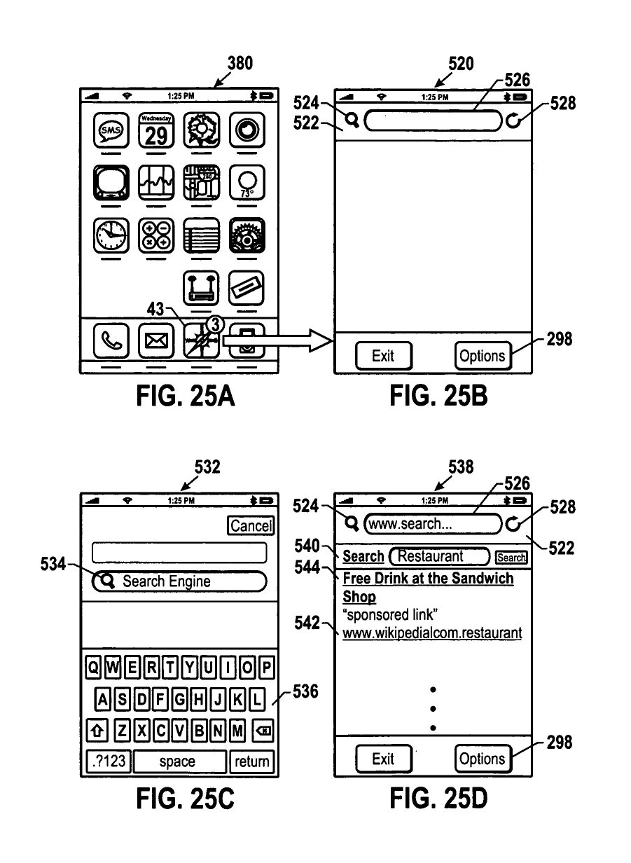

FIGS. 25A-D illustrate a manner of performing the technique outlined in the flowchart 170 of FIG. 11. Turning first to FIG. 25A, a user may select the web browser icon 43 on the home screen 380. The handheld device may subsequently display a screen 520, as shown in FIG. 25B. The screen 520 may represent a blank webpage having a browser bar 522 with a search icon 524, a location bar 526, and a refresh icon 528. Selecting the search icon 524 may allow a user to perform a search from a default search engine. Selecting the location bar 526 may allow a user to manually input a web location. Selection the refresh icon 528 may allow a user to refresh the current information from the web location of the location bar 526. If a user selects the search icon 524, the handheld device 40 may display a screen 532, as illustrated in FIG. 25C. The screen 532 may include a search bar 534 and a keyboard pane 536. A user may input one or more search terms into the search bar 534 via the keyboard 536.

FIG. 25D illustrates a search engine results page on a screen 538, which may be displayed after a user enters a search term into the search bar 534. For example, the user may enter the search term 540 “Sandwich Shop,” the screen 538 may display the search term 540 at the top of the search engine screen, with various results 542 displayed below. In addition to general results 542, the screen 538 may display a sponsored advertisement 534, which may represent the target advertisement 124.

The sponsored advertisement 534 may be generated by the search engine based on a variety of techniques. For example, if the handheld device 40 had previously received one or more target advertisements 124 according to the techniques described above, the handheld device 40 may transmit information relating to the prior target advertisements 124 to the search engine. Based on which target advertisements 124 the handheld device 40 received and/or a response to the target advertisement 124, the search engine may select the sponsored advertisement 534. In the instant example, the search engine may select the sponsored advertisement 534 for the “Sandwich Shop” when the user searches for “restaurant” because the handheld device 40 may have received prior target advertisements 124 advertising the “Sandwich Shop.” Additionally, that the user may have previously responded to such target advertisements 124 for the “Sandwich Shop” may serve as a further basis for supplying the sponsored advertisement 534.

It should be further appreciated that, additionally or alternatively, the search engine may charge the advertiser a dynamically-generated price for the sponsored advertisement 534 according to the techniques described above. As such, the search engine may consider various marketing factors 202 and/or follow-up factors 242 indicating the efficacy of the advertisement 534. For example, the handheld device 40 may send various marketing factors 202 when the user navigates to the search engine website. Additionally or alternatively, the handheld device 40 or the subject of the advertisement 534 may establish communication with the search engine website to transmit various follow-up factors 242. The follow-up factors 242 may be sent at a predetermined time or after a purchase has been made by the user of the handheld device 40. Thus, the search engine website may effectively evaluate the efficacy of the advertisement, dynamically generating a price for the advertisement.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method comprising:
transmitting an advertisement from a first electronic device to a second electronic device, wherein the second electronic device belongs to a user and wherein the advertisement is configured for display on the second electronic device;
receiving onto the first electronic device one or more marketing factors indicating a likelihood that the user will be receptive to the advertisement, wherein at least one of the one or more marketing factors is received from the second electronic device; and
determining a price to charge an advertiser for transmitting the advertisement to the user, wherein the price is determined based at least in part on the one or more marketing factors.

2. The method of claim 1, wherein determining the price comprises determining a higher price if the one or more marketing factors indicate a higher likelihood that the user will be receptive to the advertisement and determining a lower price if the one or more marketing factors indicate a higher likelihood that the user will be receptive to the advertisement.

3. The method of claim 1, wherein receiving the one or more marketing factors comprises receiving data indicating a time of day when the advertisement was provided; a location of the user or the second electronic device when the advertisement was provided; prior success in marketing to the user; user preferences stored on the second electronic device; a current weather or weather forecast; a search history or web history of the user; contents of a media library on the second electronic device; user membership in a loyalty program; any of the above factors as applied to family or friends of the user; or any combination thereof.

4. The method of claim 1, wherein receiving the one or more marketing factors comprises obtaining at least one of the one or more marketing factors from a source other than the second electronic device.

5. The method of claim 4, wherein the at least one of the one or more marketing factors obtained from the source other than the second electronic device is obtained from a wireless base station configured to provide network access to the second electronic device.

6. The method of claim 1, wherein the at least one of the one or more marketing factors received onto the first electronic device from the second electronic device is received over a local wireless network.

7. The method of claim 1, wherein transmitting the advertisement to the second electronic device comprises transmitting the advertisement to a portable phone or handheld device.

8. The method of claim 1, comprising receiving the advertisement from the advertiser prior to transmitting the advertisement to the second electronic device, wherein the advertiser comprises an advertising agency; a tenant or lessee; a private individual; a chamber of commerce; or any combination thereof.

9. The method of claim 8, wherein receiving the advertisement from the advertiser comprises receiving information regarding subject matter of the advertisement, wherein the information regarding the subject matter of the advertisement comprises an indication of a product or service advertised in the advertisement; times of day when purchases of the product or service are likely; a location of a business advertised in the advertisement; keywords relating to the business; an indication of how weather may affect the business; an indication of which user preferences indicate that purchases of the product or service are more likely; an indication of which contents of a media library indicate that purchases of the product or service are more likely; access to a database indicating members of a loyalty program of the business; or any combination thereof.

10. A method comprising:
paying a price to an infrastructure owner or manager in exchange for providing an advertisement to an electronic device belonging to a user, wherein the infrastructure owner or manager controls network infrastructure configured to transmit the advertisement to the electronic device, wherein the price is dynamically determined based on a likelihood that the user will be receptive to the advertisement when the advertisement is provided, wherein the likelihood is based at least in part on at least one marketing factor, wherein the at least one marketing factor is provided by the electronic device.

11. The method of claim 10, wherein paying the price comprises paying the price electronically after receiving an electronic bill from the infrastructure owner or manager.

12. The method of claim 10, wherein paying the price to the infrastructure owner or manager comprises paying the price to a search engine or website owner or manager; an Internet service provider; a mall or casino owner or manager providing Internet access; a municipality providing Internet access; a museum, airport, or any other publicly-accessible building owner, manager, or lessor providing Internet access; a store, restaurant, or any other publicly-accessible building tenant or lessee providing Internet access; a private individual providing Internet access; a wireless cellular network operator or owner; or any combination thereof.

13. The method of claim 10, wherein the likelihood is determined based on another marketing factor obtained from a source other than the electronic device.

14. The method of claim 10, wherein the price is dynamically determined based at least in part on the at least one marketing factor, wherein the at least one marketing factor comprises a time of day when the advertisement was provided; a location of the user or the electronic device when the advertisement was provided; prior success in marketing to the user; user preferences stored on the electronic device; a current weather or weather forecast; a search history or web history of the user; contents of a media library on the electronic device; user membership in a loyalty program; any of the above factors as applied to family or friends of the user; or any combination thereof.

15. The method of claim 10, wherein the wherein the price is dynamically determined based at least in part on the at least one marketing factor and wherein data indicating the at least one marketing factor is provided by the electronic device to a computer belonging to the infrastructure owner or manager.

16. The method of claim 10, wherein the price is dynamically determined by a computer belonging to the infrastructure owner or manager.

17. An electronic device comprising:
a processor configured to run an electronic advertisement management application;
a memory device operably coupled to the processor and configured to store an electronic advertisement associated with the electronic advertisement management application;
an electronic display operably coupled to the processor and configured to display the electronic advertisement; and
a network interface configured to receive the electronic advertisement from a computer belonging to an infrastructure owner or manager and to send to the computer at least one marketing factor indicating a likelihood whether the electronic advertisement will be effective in marketing to a user of the electronic device, wherein the computer is configured to dynamically generate a price for the electronic advertisement to charge an advertiser based at least in part on the at least one marketing factor.

18. The electronic device of claim 17, comprising a near field communication interface configured to receive advertising data from a radio frequency identification tag via near field communication, wherein the advertising data is configured to enable the electronic device to obtain the electronic advertisement from the computer belonging to the infrastructure owner or manager.

19. The electronic device of claim 17, wherein the network interface is configured to send to the computer the at least one marketing factor, wherein the at least one marketing factor comprises a time of day when the advertisement was provided; a location of the user or the electronic device when the advertisement was provided; prior success in marketing to the user; user preferences stored on the electronic device; a current weather or weather forecast; a search history or web history of the user; contents of a media library on the electronic device; user membership in a loyalty program; any of the above factors as applied to family or friends of the user; or any combination thereof.

20. The electronic device of claim 17, wherein the electronic advertisement management application is a standalone advertisement management application; a web browser application; an online map application; a wireless network management application; an application integrated into an operating system; or any combination thereof.

21. A method comprising:
marketing a dynamically-priced advertisement package to an advertiser, wherein marketing the dynamically-priced advertisement package comprises recommending charging a dynamically-generated price for providing an advertisement to an electronic device belonging to a user based at least in part on at least one marketing factor indicating a likelihood that the user will be receptive to the advertisement, wherein the at least one marketing factor is obtained from the electronic device.

22. The method of claim 21, wherein recommending charging the dynamically-generated price comprises charging a higher price if the at least one marketing factor indicates a higher likelihood that the user will be receptive to the advertisement or a lower price if the at least one marketing factor indicates a lower likelihood that the user will be receptive to the advertisement.

23. The method of claim 21, wherein marketing the dynamically-priced advertisement package comprises recommending charging the dynamically-generated price based at least in part on a time of day when the advertisement was provided; a location of the user or the electronic device when the advertisement was provided; prior success in marketing to the user; user preferences stored on the electronic device; a current weather or weather forecast; a search history or web history of the user; contents of a media library on the electronic device; user membership in a loyalty program; any of the above factors as applied to family or friends of the user; or any combination thereof.

24. An electronic device comprising:
a processor configured to run a dynamic advertisement pricing application;
a memory device operably coupled to the processor and configured to store data associated with the dynamic advertisement pricing application; and
a network interface configured to send an electronic advertisement to a personal device belonging to a user and to receive from the personal device at least one marketing factor indicating a likelihood of whether the electronic advertisement will be effective in marketing to the user, wherein the dynamic advertising pricing application is configured to dynamically generate a price for the electronic advertisement based at least in part on the at least one marketing factor.

25. The electronic device of claim 24, wherein the network interface is configured to receive from the personal device the at least one marketing factor, wherein the at least one marketing factor comprises a time of day when the advertisement was sent; a location of the user or the electronic device when the advertisement was sent; prior success in marketing to the user; user preferences stored on the electronic device; a current weather or weather forecast; a search history or web history of the user; contents of a media library on the personal device; user membership in a loyalty program; any of the above factors as applied to family or friends of the user; or any combination thereof.

26. The device of claim 24, wherein the dynamic advertising pricing application is configured to dynamically generate a price for the electronic advertisement to charge an advertiser, wherein the advertiser comprises an advertising agency; a tenant or lessee; a private individual; a chamber of commerce; or any combination thereof.
